(19) United States
(12) Patent Application Publication
(10) Pub. No.: US 2024/0161058 A1
(43) Pub. Date: May 16, 2024

(54) ITEM MANAGEMENT SYSTEM, ITEM MANAGEMENT METHOD, AND INFORMATION PROCESSING APPARATUS

(71) Applicant: CANON KABUSHIKI KAISHA, Tokyo (JP)

(72) Inventor: TOSHIFUMI KITAMURA, Shizuoka (JP)

(21) Appl. No.: 18/422,577

(22) Filed: Jan. 25, 2024

Related U.S. Application Data
(63) Continuation of application No. PCT/JP2022/024575, filed on Jun. 20, 2022.

(30) Foreign Application Priority Data
Aug. 4, 2021 (JP) 2021-128451

(51) Int. Cl. G06Q 10/087; G06K 7/10

(52) U.S. Cl. CPC G06Q 10/087; G06K 7/10297

(57) ABSTRACT

There is provided an item management system including a plurality of wireless devices respectively attached to a plurality of items, a reading apparatus capable of reading identification information stored in a wireless device, and a management unit that manages a database storing position information of the items, where the database further stores item aggregation data that defines an item aggregation including N items (N is an integer equal to or larger than two) out of the plurality of items, and the management unit updates the position information of the N items included in the item aggregation in accordance with the item aggregation data in a case where at least M wireless devices (M is an integer smaller than N) out of wireless devices attached to the N items have been detected by the reading apparatus.

### CROSS-REFERENCE TO RELATED APPLICATIONS

This application is a Continuation of International Patent Application No. PCT/JP2022/024575, filed Jun. 20, 2022, which claims the benefit of Japanese Patent Application No. 2021-128451, filed Aug. 4, 2021, both of which are hereby incorporated by reference herein in their entirety.

### BACKGROUND OF THE INVENTION

### Field of the Invention

The present disclosure relates to an item management system, an item management method, and an information processing apparatus.

### Background Art

Radio frequency identification (RFID) is a technology that allows information embedded in a small device which is also referred to as a tag to be read by an external reader through short-range wireless communication. For example, an RFID tag in which unique identification information is embedded is attached to an item so that a location of the item can be efficiently known for item stock and distribution management and that visualization of information on managed items becomes easier. Among others, a passive type RFID tag, which transmits information utilizing energy of electromagnetic wave emitted from a reader, does not require a battery, leading to low manufacturing cost and semipermanent operation. Hence, it has become widely-used not only in the stock and distribution management but also in various applications.

Patent Literature 1 discloses an example of a system which makes use of RFID tags for item stock management purpose. The system of Patent Literature 1 can easily determine, at timings of arrival, shipping and inventory counting, stock statuses by a server gathering and processing information that has read by a reader (also referred to as a scanner) from RFID tags attached to items, for example.

### CITATION LIST

### Patent Literature

PTL 1: Japanese Patent Laid-Open No. 2002-150241

However, in a case where a plurality of items are placed close to each other in the same place, propagation paths of electromagnetic waves between the reader and RFID tags are likely to be obstructed by items or other obstacles. In this case, item management often becomes cumbersome as detection of all the items requires long time or a user is forced to tilt the reader at various angles.

In light of the foregoing, the present invention aims at providing a mechanism that enhances efficiency of item management.

### SUMMARY OF THE INVENTION

According to an aspect, there is provided an item management system including: a plurality of wireless devices that are respectively attached to a plurality of items; a reading apparatus that is capable of reading identification information stored in a wireless device; and a management unit configured to manage a database that stores position information of the plurality of items, wherein the database further stores item aggregation data that defines an item aggregation including N items (N is an integer equal to or larger than two) out of the plurality of items, and the management unit is configured to update the position information of the N items included in the item aggregation in accordance with the item aggregation data in a case where at least M wireless devices (M is an integer smaller than N) out of wireless devices attached to the N items have been detected by the reading apparatus. A corresponding method and an information processing apparatus are also provided.

Further features of the present invention will become apparent from the following description of exemplary embodiments with reference to the attached drawings.

### BRIEF DESCRIPTION OF THE DRAWINGS

FIG. 1 is a schematic view illustrating an example of a configuration of an item management system according to an embodiment.

FIG. 2 is a block diagram illustrating an example of a configuration of a tag reader according to an embodiment.

FIG. 3 is a block diagram illustrating an example of a configuration of a management server according to an embodiment.

FIG. 4A is an explanatory diagram illustrating an example of a configuration of an item table according to an embodiment.

FIG. 4B is an explanatory diagram illustrating an example of a configuration of a place table according to an embodiment.

FIG. 4C is an explanatory diagram illustrating an example of a configuration of a reader table according to an embodiment.

FIG. 4D is an explanatory diagram illustrating an example of a configuration of a user table according to an embodiment.

FIG. 5A is an explanatory diagram illustrating an example of a configuration of a movement amount table according to an embodiment.

FIG. 5B is an explanatory diagram illustrating an example of a configuration of a tag detection table according to an embodiment.

FIG. 6 is an explanatory diagram illustrating an example of a configuration of an aggregation table according to an embodiment.

FIG. 7 is an explanatory diagram for explaining a first practical example of a user interface (UI) for management of item aggregation data.

FIG. 8 is an explanatory diagram for explaining a second practical example of a UI for management of item aggregation data.

FIG. 9 is a first explanatory diagram for specifically explaining position tracking in an item aggregation.

FIG. 10 is a second explanatory diagram for specifically explaining position tracking as an item aggregation.

FIG. 11 is a first explanatory diagram for specifically explaining cancellation of a definition of an item aggregation.

FIG. 12A is a second explanatory diagram for specifically explaining cancellation of a definition of an item aggregation.

FIG. 12B is a third explanatory diagram for specifically explaining cancellation of a definition of an item aggregation.

FIG. 13 is an explanatory diagram for explaining an example of a UI for inquiry of position information.

FIG. 14 is a flowchart illustrating an example of a flow of a tag reading process performed by a tag reader.

FIG. 15 is a flowchart illustrating an example of a flow of an aggregation registration/edit process performed by a management server.

FIG. 16 is a flowchart illustrating an example of a flow of a data reception process performed by a management server.

FIG. 17 is a flowchart illustrating an example of a flow of an aggregation position update process performed by a management server.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### 1. System Overview

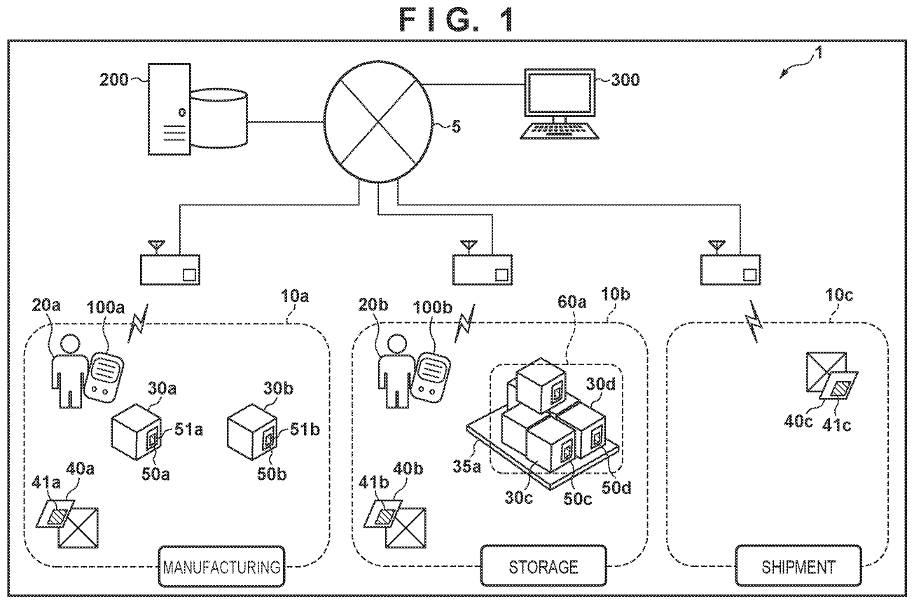

FIG. 1 is a schematic view illustrating an example of a configuration of an item management system 1 according to an embodiment. The item management system 1 is a system that manages, in a database, information related to a plurality of items. In the present embodiment, the item management system 1 at least manages position information that indicates positions of the items. The position information may indicate a position of each item by two-dimensional or three-dimensional positional coordinates or by an identifier that identifies one of a plurality of predefined places as a location of the item, for example. An item may be a non-living object (for example, a machine, equipment, a tool, material, a consumable good, a component, a vehicle, or a robot) or a living object (for example, an animal or a plant).

The item management system 1 may be utilized for various purposes such as production management, stock management, or distribution management at any place such as a factory, warehouse, logistics base, or sales office. FIG. 1 illustrates three places 10a, 10b and 10c under management of the item management system 1. There are items 30a and 30b in the place 10a. There are multiple items including items 30c and 30d in the place 10b. FIG. 1 further illustrates users 20a and 20b. The user 20a carries or wears a tag reader 100a. The user 20b carries or wears a tag reader 100b. Each user 20a, 20b may move among the places 10a, 10b and 10c, and is involved in operations such as manufacturing, storage, shipping or the like, or supervises these operations.

In the item management system 1, a plurality of items 30 sometimes form an item aggregation. To give a few examples, an item aggregation may be formed by manufacturing a product using the items as members, assembling the items to form an assembly, packing the items into a package, putting the items into a container, or stacking the items on a certain supporting body. In the present specification, the ‘item aggregation’ (also simply referred to as ‘aggregation’) refers to an aggregation of items, for example, that are able to move together as a result of having been linked to each other, assembled, stacked, or put into the same container, etc. In the example of FIG. 1, the six items 30 including the item 30c and 30d are stacked on the same transportation pallet 35a in the place 10b. The item aggregation 60a is an aggregation that includes these six items as constituent items which are able to move together. The item aggregation 60a can move by being transported by a user or a machine. As described in detail below, the item management system 1 allows a definition of such an item aggregation including N items (N is an integer equal to or larger than two) to be registered in a database, and realizes position information management on a per-item-aggregation basis.

The item management system 1 makes use of wireless devices, which are also referred to as tags, for the purpose of item information management. Position tags are wireless devices which are installed in respective places 10a, 10b and 10c where an item may be placed in the item management system 1. FIG. 1 shows a position tag 40a installed in the place 10a, a position tag 40b installed in the place 10b, and a position tag 40c installed in the place 10c. The installation position of each of the position tags 40a, 40b and 40c may be fixed or can be changed. When a place itself moves, the corresponding position tag may be relocated in conjunction with the movement of the place.

Item tags are wireless devices which are attached to respective items managed in the item management system 1. FIG. 1 shows an item tag 50a attached to the item 30a, an item tag 50b attached to the item 30b, an item tag 50c attached to the item 30c, an item tag 50d attached to the item 30d, and so on.

Note that, in the following descriptions, the places 10a, 10b and 10c are collectively referred to as places 10 by omitting the trailing alphabets from the reference signs when they do not need to be distinguished from each other. The same applies to the users 20 (user 20a, 20b), the items 30 (items 30a, 30b, . . . ), the position tags 40 (40a, 40b, . . . ), the item tags 50 (item tags 50a, 50b, . . . ), and the tag readers 100 (tag readers 100a, 100b), as well as other elements. The number of places 10 and the number of items 30 managed in the item management system 1 are not limited to the example illustrated in FIG. 1, but may be any numbers. Likewise, the number of users 20 utilizing the item management system 1 and the number of tag readers 100 are also not limited to the example illustrated in FIG. 1, but may be any numbers.

In the present embodiment, each of the tags such as the position tags 40 and the item tags 50 is assumed to be a passive-type RFID tag (a passive tag). A passive tag is composed of: a small integrated circuit (IC) chip with an embedded memory; and an antenna, and has identification information for identifying the tag and some other information stored in the memory. In this specification, identification information is simply referred to as an ID, and identification information for identifying a tag is referred to as a tag ID. It should be noted that the tag ID may be considered as information for identifying an object to which the tag is attached. In the example of FIG. 1, the position tags 40a, 40b and 40c have specific tag IDs 41a, 41b and 41c embedded in the tags, respectively. The item tags 50 and 50b have specific tag IDs 51a and 51b embedded in the tags, respectively. The IC chip of a passive tag operates by utilizing energy of an electromagnetic wave emitted from a tag reader, and modulates the information such as the tag ID and some other information stored in the memory into an information signal to transmit (send back) the information signal from the antenna.

It should be noted that, in another embodiment, each tag may be an active-type RFID tag. If each tag actively (for example, periodically) transmits information to its vicinity by utilizing power from a built-in battery, such a tag may be called a beacon tag. In a further embodiment, each tag may be a wireless device which sends back information in response to a signal from a reader in accordance with Near Field Communication (NFC) protocol or Bluetooth (registered trademark) protocol, for example. Each tag may have any name such as an IC tag, an IC card, or a responder.

The item management system 1 includes the tag readers 100, a management server 200, and a user terminal 300. The tag readers 100, the management server 200, and the user terminal 300 are connected to a network 5. The network 5 may be a wired network, a wireless network, or any combination thereof. Examples of the network 5 may include the Internet, an intranet, and a cloud network.

The tag reader 100 is a reading apparatus that is capable of reading information stored in wireless devices such as RFID tags. The tag reader 100 can detect an item 30 to which an item tag 50 is attached by reading a tag ID 51 from the item tag 50, for example. The tag reader 100 performs reading periodically or in response to a certain trigger such as a user operation, and transmits a tag reading result to the management server 200. The tag reader 100 may be capable of communicating with the management server 200 directly or indirectly via a certain relay apparatus. An example of a particular configuration of the tag reader 100 will be further described below.

The management server 200 is an information processing apparatus that manages position information of a plurality of items 30 and other information in a database. The management server 200 may be implemented as an application server, a database server, or a cloud server by using a high-end general-purpose computer, for example. The management server 200 receives tag reading results from respective tag readers 100, and updates the database such that it reflects the latest management statuses of the respective items 30 based on the received tag reading results. The management server 200 also has an information provision function to provide a user 20 with information related to the items 30. The information related to the items 30 is typically provided to a user on a screen of the user terminal 300. An example of a particular configuration of the management server 200 will be further described below.

In the example in FIG. 1, the management server 200 is a cloud server deployed in a cloud environment. Though a single management server 200 is illustrated in FIG. 1, the functions of the management server 200, which will be described in detail below, may be provided by a single apparatus or by physically-separate multiple apparatuses which operate in conjunction with each other. In addition, though an example where the management server 200 maintains a database including the information related to the items 30 will be described in the present embodiment, an apparatus other than the management server 200 may maintain a part or all of the database. For example, a part of data may be maintained by a wireless device (for example, a position tag or an item tag) or by a tag reader.

The user terminal 300 is a terminal apparatus that is utilized by a user 20 of the item management system 1. The user terminal 300 may be a general-purpose terminal such as a personal computer (PC) or a smartphone, or a dedicated terminal specialized for an item management purpose. The user terminal 300 may be portable or stationary. The user terminal 300 typically comprises an input device that receives user inputs, a communication interface that communicates with other apparatuses (for example, the management server 200), and a display device that displays information. As an example, the user terminal 300 is utilized by a user 20 to make inquiries to the management server 200 about the position information. As another example, the user terminal 300 is utilized by a user 20 to register, in the database, a definition of an item aggregation consisting of a plurality of items 30. Examples of user interfaces provided to a user 20 in these situations will further be described below.

It should be noted that, though FIG. 1 illustrates the tag reader 100 and the user terminal 300 as separate apparatuses, there may be provided an integrated apparatus which has both of functionalities of the tag reader 100 and the user terminal 300. Moreover, the user terminal 300 carried by a user 20 may relay communication between the tag reader 100 and the management server 200.

### 2. Configuration Example of Tag Reader

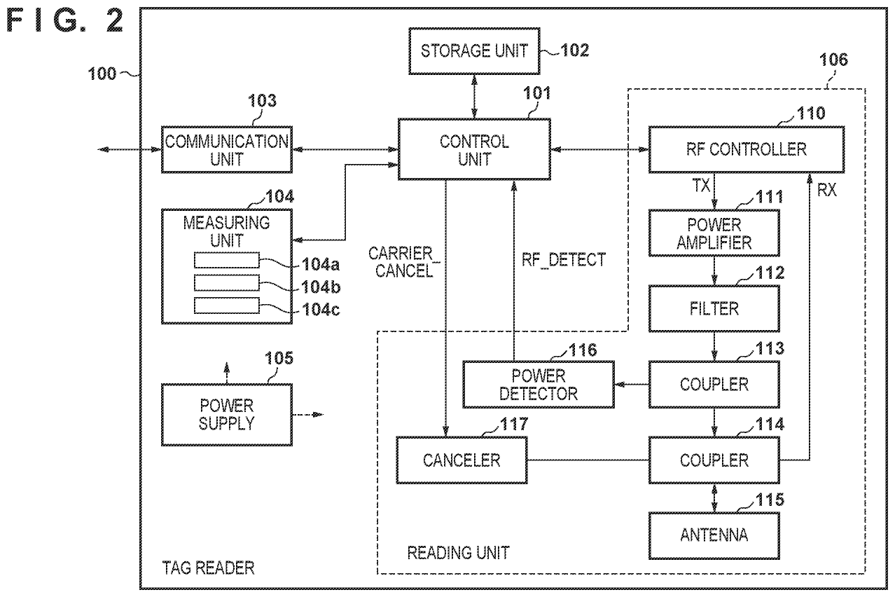

FIG. 2 is a block diagram illustrating an example of a configuration of the tag reader 100 according to an embodiment. With reference to FIG. 2, the tag reader 100 comprises a control unit 101, a storage unit 102, a communication unit 103, a measuring unit 104, a power supply 105, and a reading unit 106.

The control unit 101 consists of a memory to store computer programs, and one or more processors (for example, central processing units (CPUs)) to execute the computer programs. The control unit 101 controls overall functionality of the tag reader 100 described in this specification. For example, the control unit 101 causes the reading unit 106 to perform reading from an RFID tag within a tag reading range, and causes the storage unit 102 to temporarily store the read information and the time of the reading as reading result data. In parallel to the reading from RFID tags, the control unit 101 also causes the measuring unit 104 to measure the position of the tag reader 100, and the storage unit 102 to store a measurement result. Then, the control unit 101 transmits, to the management server 200 via the communication unit 103, the reading result data and the measurement result data stored in the storage unit 102 together with the reader identification information (also referred to as a reader ID) of the tag reader 100.

The storage unit 102 may include any kind of storage medium such as a semiconductor memory (a read only memory (ROM), a random access memory (RAM), or the like), an optical disk, or a magnetic disk, for example. In the present embodiment, the storage unit 102 stores the above-described reading result data, measurement result data, and the reader ID of the tag reader 100.

The communication unit 103 is a communication interface for the tag reader 100 to communicate with the management server 200. For example, the communication unit 103 may be a wireless local area network (WLAN) interface that communicates with a WLAN access point, or a cellular communication interface that communicates with a cellular base station. Alternatively, the communication unit 103 may be a connection interface (e.g. a Bluetooth (registered trademark) interface or a universal serial bus (USB) interface) for connection with a relay apparatus.

The measuring unit 104 is a positioning module that measures a position of the tag reader 100. In the present embodiment, the measuring unit 104 measures an amount of relative movement of the tag reader 100 from a certain starting point, and outputs the measured amount of movement to the control unit 101. The reference position of measurement of the amount of relative movement may be, for example, the position of the tag reader 100 at the time when the tag reader 100 is activated. The amount of relative movement of the tag reader 100 may be treated as a relative position. For example, the measuring unit 104 includes three-axis acceleration sensor 104a, gyro sensor 104b, and geomagnetic sensor 104c. The three-axis acceleration sensor 104a measures acceleration applied to the tag reader 100 in the device coordinate system that is specific to the tag reader 100, and outputs first sensor data. The gyro sensor 104b measures an angular speed of the tag reader 100, that is, a change in attitude of the tag reader, to output second sensor data. The geomagnetic sensor 104c measures an orientation of the tag reader 100 in the real space to output third sensor data. The measuring unit 104 can measure the amount of relative movement of the tag reader 100 based on these pieces of sensor data by converting the direction of the acceleration of the tag reader 100 into a direction in a coordinate system of the real space to integrate the converted acceleration. The measurement of an amount of movement here may be performed in accordance with any publicly-known self-localization technique (also referred to as pedestrian dead reckoning (PDR)). The amount of relative movement of the tag reader 110 output from the measuring unit 104 to the control unit 101 may be a two-dimensional vector in a horizontal plane or a three-dimensional vector that includes a component of height direction as well.

As described below, in the present embodiment, the positional coordinates of the installation position of each position tag 40 is known and registered in a database. Therefore, the current (positional coordinates of) absolute position of the tag reader 100 can be derived based on the amount of relative movement of the tag reader 100 from the time point where it detected a position tag 40 to the current time point, and the known positional coordinates of that position tag 40. In the present embodiment, an example where the management server 200 derives the absolute position of the tag reader 100 is mainly described, however, the control unit 101 or the measuring unit 104 of the tag reader 100 may access the database to derive the absolute position of the tag reader 100. In another embodiment, the measuring unit 104 may measure the current geographical position of the tag reader 100 by utilizing the global positioning system (GPS). In yet another embodiment, the measuring unit 104 may perform base station positioning or wireless LAN positioning in which the current position is estimated by utilizing known positional coordinates of a base station or a wireless LAN access point to which the apparatus is connected.

It should be noted that, though FIG. 2 illustrates an example where the tag reader 100 includes the measuring unit 104, the measuring unit 104 may be included in an external device that is capable of communicating with the tag reader 100 and is carried by the user along with the tag reader 100. In that case, the tag reader 100 receives, from the external device, movement amount information indicating a relative amount of movement measured by the measuring unit 104.

The power supply 105 includes a battery and a DC-DC converter, and supplies power for operating electronic circuits of the control unit 101, the storage unit 102, the communication unit 103, the measuring unit 104 and the reading unit 106 of the tag reader 100. The battery may include a primary cell, or a rechargeable secondary cell. Although not illustrated in the figure, the tag reader 100 may have a connection terminal for connecting the tag reader 100 to an external power source for recharging the power supply 105.

The reading unit 106 is a reading module that is capable of reading, from each of the position tags 40 and the item tags 50 under management of the item management system 1, information stored in that tag. With reference to FIG. 2, the reading unit 106 includes an RF controller 110, a power amplifier 111, a filter 112, a first coupler 113, a second coupler 114, an antenna 115, a power detector 116, and a canceler 117. The RF controller 110 outputs a transmission signal (for example, a signal modulated in the UHF band) from a TX terminal to the power amplifier 111 in accordance with control by the control unit 101. The power amplifier 111 amplifies the transmission signal input from the RF controller 110 to output it to the filter 112. The filter 112 may be a low-pass filter, for example, and filters out unnecessary frequency components from the transmission signal amplified by the power amplifier 111. The first coupler 113 distributes the transmission signal that has passed the filter 112 to the coupler 114 and the power detector 116. The second coupler 114 outputs the transmission signal input from the first coupler 113 to the antenna 115, and outputs a received signal input from the antenna 115 to the RF controller 110. The antenna 115 transmits the transmission signal input from the coupler 114 to the air as an electromagnetic wave. Further, the antenna 115 receives a signal that has been sent back from an RFID tag that exists within the reading range of the tag reader 100 in response to the transmission signal, and outputs the received signal to the coupler 114. The power detector 116 detects a power level of the signal input from the first coupler 113, and outputs a signal ‘RF_DETECT’ indicative of the detected power level to the control unit 101. The canceler 117 receives a signal ‘CARRIER_CANCEL’ indicative of a power level of a carrier from the control unit 101. Then, the canceler 117 extracts an intended signal component of the received signal to be output to an RX terminal of the RF controller 110 by canceling the carrier component of the transmission signal based on the CARRIER_CANCEL. The RF controller 110 demodulates the signal input from the RX terminal to obtain the tag ID and other information sent back from the RFID tag, and outputs the obtained information to the control unit 101.

In the present embodiment, the reading unit 106 can attempt tag reading periodically (for example, once per second) without requiring any explicit command from a user. Data transmission from the communication unit 103 to the management server 200 can also be performed periodically (for example, every few seconds) or whenever the tag reading is done without requiring any explicit command from a user. The control unit 101 may exclude, from the data to be transmitted, the same record as the most recent record that has already been transmitted in a predetermined time period to omit redundant data transmission and reduce a communication load. It should be noted that, in another embodiment, one or both of an attempt of tag reading by the reading unit 106 and data transmission to the management server 200 may be performed in response to a user input via a certain user interface arranged in the tag reader 100. In a case where the communication unit 103 performs communication with the management server 200 indirectly via a relay apparatus, the data transmission to the management server 200 may be performed only while there is an effective connection between the communication unit 103 and the relay apparatus.

### 3. Configuration Example of Management Server

### 3-1. Basic Configuration

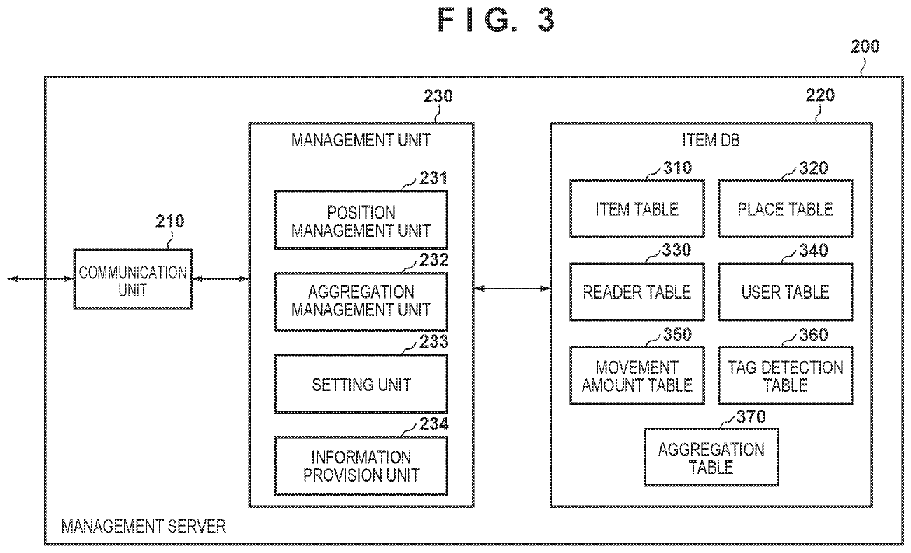

FIG. 3 is a block diagram illustrating an example of a configuration of the management server 200 according to an embodiment. With reference to FIG. 3, the management server 200 comprises a communication unit 210, an item database (DB) 220, and a management unit 230.

The communication unit 210 is a communication interface for the management server 200 to communicate with other apparatuses. The communication unit 210 may be a wired communication interface or a wireless communication interface. In the present embodiment, the communication unit 210 communicates with the tag readers 100 and the user terminals 300 within the item management system 1. The item DB 220 is a database that stores position information of a plurality of items under management of the system and other information. In the present embodiment, the item DB 220 includes an item table 310, a place table 320, a reader table 330, a user table 340, a movement amount table 350, a tag detection table 360, and an aggregation table 370. The management unit 230 is a set of software modules that provide management functions for managing data within the item DB 220. The individual software modules can run by one or more processors (not shown) of the management server 200 executing computer programs stored in a memory (not shown). In the present embodiment, the management unit 230 includes a position management unit 231, an aggregation management unit 232, a setting unit 233, and an information provision unit 234.

### 3-2. Data Configuration Examples

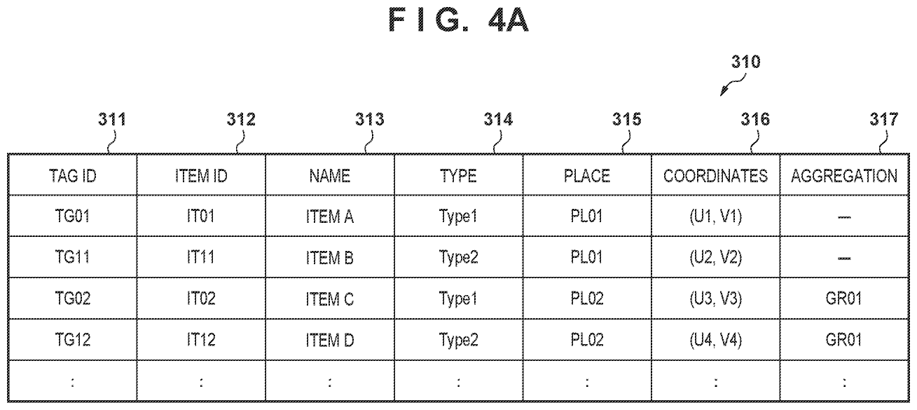

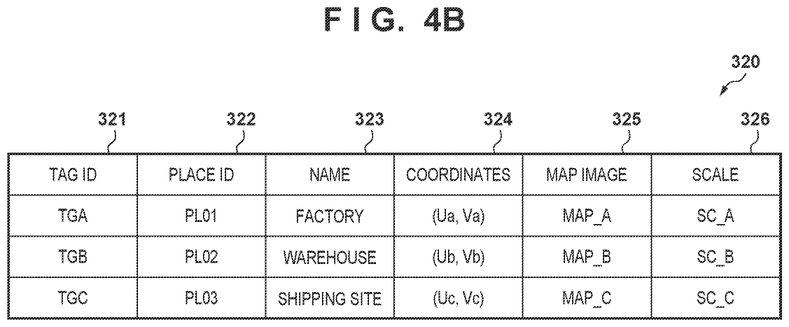

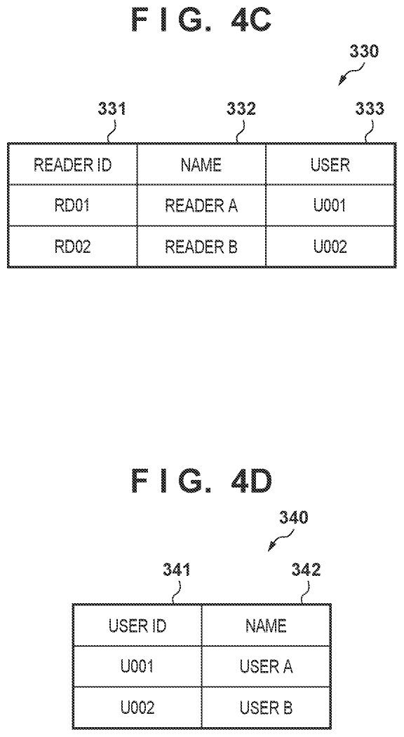

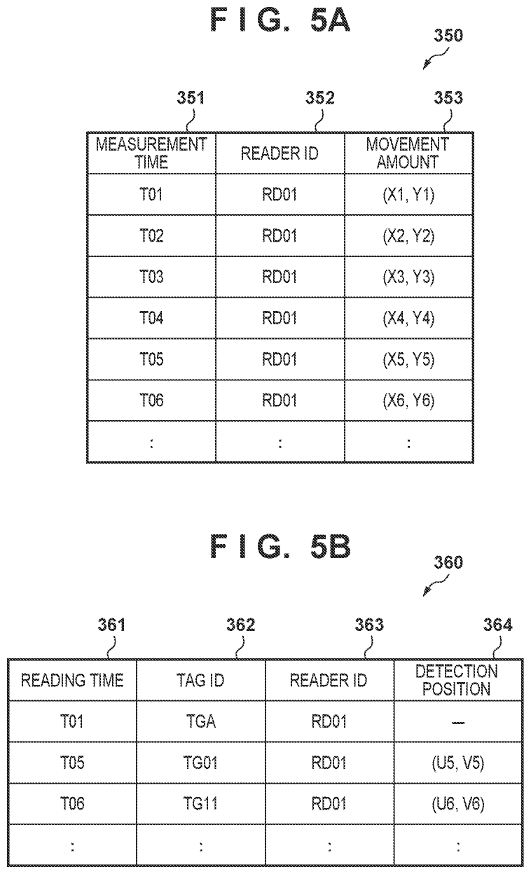

FIGS. 4A to 4D illustrate respective configuration examples of the item table 310, the place table 320, the reader table 330, and the user table 340 of the item DB 220. FIGS. 5A and 5B illustrate respective configuration examples of the movement amount table 350 and the tag detection table 360 of the item DB 220.

The item table 310 has seven data elements, namely Tag ID 311, Item ID 312, Name 313, Type 314, Place 315, Coordinates 316, and Aggregation 317. Tag ID 311 is identification information that uniquely identifies an item tag 50 attached to each of the items 30 under management of the system. The value of Tag ID 311 is the same as the value of the tag ID stored within the corresponding item tag 50. Item ID 312 is identification information that uniquely identifies each item 30. Name 313 represents a name of each item 30. In the example of FIG. 4A, the items identified by item IDs “IT01”, “IT11”, “IT02” and “IT12” are given the names of “Item A”, “Item B”, “Item C” and “Item D”, respectively. “Item A”, “Item B”, “Item C” and “Item D” here may correspond respectively to the items 30a, 30b, 30c and 30d illustrated in FIG. 1. Type 314 represents a type into which each item 30 is classified. In the example of FIG. 4A, the type of “Item A” and “Item C” is “Type 1”, and the type of “Item B” and “Item D” is “Type 2”. The values of Name 313 and Type 314 of each item 30 are determined by a user, and may be registered in advance via a user interface provided by the management unit 230. Alternatively, the values of Name 313 and Type 314 may be stored in item tags 50 as item-related information and read by a tag reader 100. In the latter case, upon initial tag reading from the item tag 50 of each item 30, the management server 200 may receive the values of Name 313 and Type 314 of that item 30 from the tag reader 100, and register them in the item table 310. Place 315 represents a place where each item 30 has been last detected by a tag reader 100 with a place ID identifying that place. In the example of FIG. 4A, “Item A” and “Item B” exist in the place identified by the place ID “PL01”. “Item C” and “Item D” exist in the place identified by the place ID “PL02”. Coordinates 316 represents latest positional coordinates of a point at which each item 30 is located. The values of Place 315 and Coordinates 316 may be updated by the position management unit 231 when the tag reader 100 has detected a movement of an item as will be described below. Aggregation 317 may be treated as the item aggregation data that defines, in conjunction with the aggregation table 370 described below, an item aggregation including N items 30 (N is an integer equal to or larger than two). Aggregation 317 represents an item aggregation to which each item 30 belongs with an aggregation ID identifying that item aggregation when each item 30 is a constituent item of the item aggregation. The meaning of Aggregation 317 will be described in detail below.

The place table 320 has six data elements, namely Tag ID 321, Place ID 322, Name 323, Coordinates 324, Map Image 325, and Scale 326. Tag ID 321 is identification information that uniquely identifies a position tag 40 installed in each of the places 10 under management of the system. The value of Tag ID 321 is the same as the value of the tag ID stored within the corresponding position tag 40. Place ID 322 is identification information that uniquely identifies each place 10. Name 323 represents a name of each place 10. In the example of FIG. 4B, the name of the place 10 identified by the place ID “PL01” is “Factory”, the name of the place 10 identified by the place ID “PL02” is “Warehouse”, and the name of the place identified by the place ID “PL03” is “Shipping Site”. “Factory”, “Warehouse”, and “Shipping Site” here may correspond respectively to the places 10a, 10b, and 10c illustrated in FIG. 1. Coordinates 324 represents positional coordinates of an installation position of a position tag 40 installed in each place 10. Map Image 325 is a data element in which map image data of each place 10 is stored. Scale 326 indicates a ratio for converting a distance on the map of Map Image 325 into a distance in the real space (for example, how many meters in the real space one pixel of the image corresponds to). Note that the map image data stored in Map Image 325 may be updated with one obtained from an external data source or uploaded by a user at necessary timings.

The reader table 330 has three data elements, namely Reader ID 331, Name 332, and User 333. Reader ID 331 is identification information that uniquely identifies each of the tag readers 100 utilized in the system. Name 332 represents a name of each reader. In the example of FIG. 4C, the name of the tag reader 100 identified by the reader ID “RD01” is “Reader A”, and the name of the tag reader 100 identified by the reader ID “RD02” is “Reader B”. “Reader A” and “Reader B” here may correspond respectively to the tag readers 100a and 100b illustrated in FIG. 1. User 333 identifies a user 20 who uses each reader 100 with a value of User ID 341 of the user table 340.

The user table 340 has two data elements, namely User ID 341 and Name 342. User ID 341 is identification information that uniquely identifies each of the users 20 who utilize the item management system 1. Name 342 represents a name of each user. In the example of FIG. 4D, the name of the user 20 identified by the user ID “U001” is “User A”, and the name of the user 20 identified by the user ID “U002” is “User B”. “User A” and “User B” here may correspond respectively to the users 20a and 20b illustrated in FIG. 1.

The movement amount table 350 is a table for accumulating records of measurement result data (hereinafter, measurement result records) received from the tag reader 100. The movement amount table 350 includes three data elements, namely Measurement Time 351, Reader ID 352, and Movement Amount 353. Measurement Time 351 indicates the time at which measurement was performed for the measurement result indicated by each measurement result record. Reader ID 352 is identification information for identifying the tag reader 100 that performed the measurement for the measurement result indicated by each measurement result record. In the example of FIG. 5A, the six records of the movement amount table 350 indicate the results of movement amount measurement performed by the tag reader 100a identified by Reader ID “RD01” at six different times “T01” to “T06”. Movement Amount 353 indicates the relative movement amount as the measurement result. Here, Movement Amount 353 represents the relative movement amount in a two-dimensional vector format in a coordinate system of the real space.

The tag detection table 360 is a table for accumulating records of reading result data (hereinafter, reading result records) received from the tag reader 100. The tag detection table 360 has four data elements, namely Reading Time 361, Tag ID 362, Reader ID 363, and Detection Position 364. Reading Time 361 indicates the time at which the tag ID was read for each reading result record. Tag ID 362 indicates the tag ID read for each reading result record. Reader ID 363 is identification information for identifying the tag reader 100 that performed tag reading for each reading result record. In the example of FIG. 5B, the first record of the tag detection table 360 indicates that the tag reader 100a identified by Reader ID “RD01” read Tag ID “TGA” (for example, the tag ID 41a of the position tag 40a of the place 10a) at Time “T01”. The second record indicates that the tag reader 100a read Tag ID “TG01” (for example, the item tag 51a of the item tag 50a of the item 30a) at Time “T05”. The third record indicates that the tag reader 100a read Tag ID “TG11” (for example, the item tag 51b of the item tag 50b of the item 30b) at Time “T06”. Detection Position 364 indicates the positional coordinates (that is, the detection position of the item tag 50 and the corresponding item 30) of a point where the tag reader 100 existed at the time when the tag was read from the item tag 50.

<3-3. Basic Position Tracking>

The position management unit 231 of the management unit 230 adds each record of measurement result data received via the communication unit 210 from each of the tag readers 100 to the movement amount table 350 as a measurement result record. Also, the position management unit 231 adds each record of the reading result data received via the communication unit 210 from each of the tag readers 100 to the tag detection table 360 as a reading result record. In a case where an item tag 50 has been detected by the tag reader 100, the position management unit 231 derives the detection position of the detected item tag 50 based on the amount of relative movement of the tag reader 100 from a detection position of a position tag 40 in the same place 10 and the known positional coordinates of the position tag 40. For example, the amount of relative movement of the tag reader 100 at the time when the item tag 50 was detected by a certain tag reader 100 is (X, Y). Also, the positional coordinates of the most recently detected position tag 40 is (U₀, V₀), and the amount of relative movement of the tag reader 100 when the position tag 40 has been detected is (X₀, Y₀). Then, the positional coordinates (U, V) of the detection position in the real space of the item tag 50 (that is, the detection position of the corresponding item 30) can be derived according to the following equation.

(U,V)=(U₀+(X−X₀),V₀+(Y−Y₀))

The position management unit 231 adds the positional coordinates indicating the detection position of the item tag 50 derived in this manner to the field of Detection Position 364 of the tag detection table 360. In addition, the position management unit 231 updates the field of Coordinates 316 of the record of the corresponding item 30 in the item table 310 with the positional coordinates indicating the latest detection position of the item tag 50. In a case where the place 10 where the item 30 exists changes, the position management unit 231 also updates the field of Place 315 of the record of the corresponding item 30 in the item table 310.

In this manner, the position management unit 231 reflects the latest status relating to at which place each of the items 30 under management of the system are stored and at which point it is located in the data in the item DB 220. Specifically, in the present embodiment, since the position information of each item 30 is updated continually without an explicit instruction by the user on the basis of results of measurement and tag reading performed by each tag reader 100, easily knowing statuses of storage of the plurality of items 30 can be realized.

### 3-4. Aggregation Management

As described in connection with the place 10b of FIG. 1, in a case where multiple items 30 are placed close to one another at the same place 10, propagation paths of electromagnetic waves between a tag reader 100 and item tags 50 are likely to be obstructed by an item 30 or other obstacles. In this case, the operation often becomes cumbersome as detection of all of the items 30 using the tag reader 100 requires a long time or the user 20 is forced to tilt the tag reader 100 at various angles. In the present embodiment, in order to reduce the cumbersomeness that comes with managing the plurality of items 30 in this manner and improve the efficiency of item management, Aggregation 317 described above, which is a data element of the item table 310, and the aggregation table 370 are incorporated into the item DB 220.

### 3-4-1. Data Configuration Example

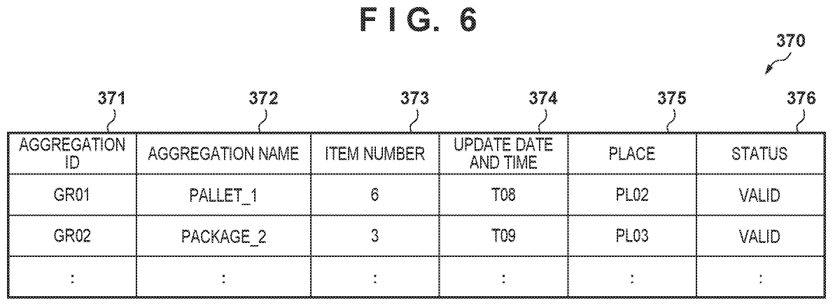

FIG. 6 illustrates an example of a configuration of the aggregation table 370, which is a table for defining an item aggregation. With reference to FIG. 6, the aggregation table 370 has six data elements, namely Aggregation ID 371, Aggregation name 372, Item Number 373, Update Date and Time 374, Place 375, and Status 376. Aggregation ID 371 is identification information for uniquely identifying each of item aggregations registered in the aggregation table 370. Aggregation name 372 represents a name of each item aggregation. The item aggregations identified by aggregation IDs “GR01” and “GR02” in the example of FIG. 4A are given the names “Pallet 1” and “Package 2”, respectively. Item Number 373 represents the number of the items 30 composing each item aggregation. Update Date and Time 374 represents a date and time that the record of each item aggregation has been last updated. Place 375 represents a place where each item aggregation has been last detected by the tag reader 100 with a place ID identifying that place. Status 376 is a flag indicating whether or not each item aggregation is valid. As described below, Status 376 for an item aggregation that has once been registered but no longer satisfies a condition for an item aggregation due to separation of a constituent item or the like may be set to “Invalid”.

In the present embodiment, a list of constituent items 30 composing each item aggregation is defined by Aggregation 317 of the item table 310. For example, with reference to FIG. 4A, Aggregation 317 of “Item C” and “Item D” is “GR01”, and thus these items 30 belong to an item aggregation identified by the aggregation ID “GR01”. On the other hand, Aggregation 317 for “Item A” and “Item B” is empty, meaning that these items 30 do not belong to an item aggregation.

Note that the configurations of the tables of the item DB 220 illustrated in FIGS. 4A to 6 are mere examples. For example, Aggregation 317 may be omitted from the item table 310 as a data element, and instead, an independent table indicating the association between each item 30 and each item aggregation may be added to the item DB 220.

### 3-4-2. Registration and Edit of Item Aggregation

The aggregation management unit 232 accepts new registration of an item aggregation by the user 20 and edit of a registered item aggregation via a user interface (UI) of the user terminal 300. In first and second practical examples to be described in the present section, a screen for the user 20 to designate a constituent item of an item aggregation is displayed on the display of the user terminal 300, and a definition of an item aggregation made of constituent items designated by the user 20 on the screen is registered in the item DB 220. In a third practical example, instead of a constituent item of an item aggregation being designated by the user 20 on a screen, a definition of an item aggregation from a data file is registered in the item DB 220.

### (1) First Practical Example

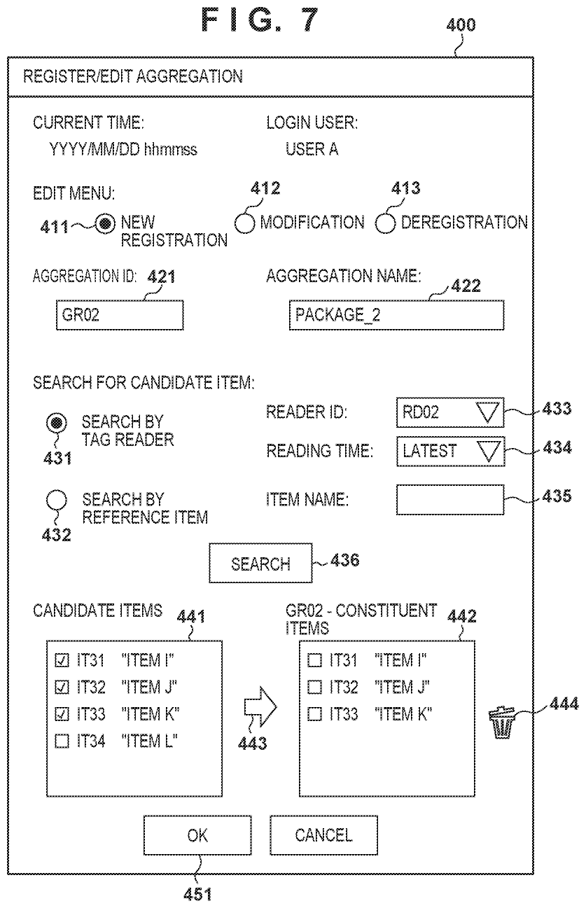

In the first practical example, the aggregation management unit 232 causes an aggregation management screen 400 (hereinafter, simply referred to as screen 400) illustrated in FIG. 7 to be displayed on the display of the user terminal 300. The screen 400 includes screen elements for allowing the user 20 to designate or select names of constituent items for an item aggregation which is subject to new registration or editing. The screen 400 may be a web screen displayed on a standard browser or may be an application screen displayed by a dedicated application for item management. The screen 400 may be displayed after successful login authentication for the item management system 1.

The screen 400 includes, for example, radio buttons 411, 412, and 413 for allowing the user to select an edit menu. The radio button 411 may be selected when newly registering an item aggregation. The radio button 412 may be selected when correcting the name of an existing item aggregation or a list of constituent items. The radio button 413 may be selected when deleting the registration of an existing item aggregation.

The screen 400 further includes an aggregation ID field 421 and an aggregation name field 422. The aggregation ID field 421 displays the aggregation ID of an existing item aggregation to be edited or an item aggregation to be newly registered. In the case of newly registering an item aggregation, the aggregation management unit 232 may automatically assign an aggregation ID for the item aggregation being newly registered to ensure the same aggregation ID of another item aggregation is not used. The aggregation name of the item aggregation being newly registered is input into the aggregation name field 422 by the user. In the case of editing an item aggregation, the user designates the aggregation ID or aggregation name of the item aggregation to be edited in the aggregation ID field 421 or the aggregation name field 422.

The screen 400 further includes radio buttons 431 and 432 for allowing the user to select a search method for searching the candidates for a constituent item of an item aggregation as well as a reader ID field 433, a reading time field 434, and an item name field 435. In addition, the screen 400 includes a search button 436, a candidate item area 441, a constituent item area 442, an add icon 443, a delete icon 444, and an OK button 451.

The radio button 431 may be selected when searching for a candidate for a constituent item from the results of tag reading by the tag reader 100. In a case where the user selects the radio button 431, the reader ID of the tag reader 100 and the reading time are designated as search conditions in the reader ID field 433 and the reading time field 434 and the search button 436 is operated. Then, the aggregation management unit 232 extracts a list of item tags 50 detected at the time close to the designated time by the designated tag reader 100 from the tag detection table 360. Then, the aggregation management unit 232 causes the list of the items 30 corresponding to the extracted item tags 50 to be displayed in the candidate item area 441.

The radio button 432 may be selected when searching for a candidate for a constituent item with a specific item 30 designated as a reference item. When the user selects the radio button 432, the name of one item constituting the item aggregation to be newly registered or edited is designated in the item name field 435, and the search button 436 is operated. Then, the aggregation management unit 232 extracts a list of the items 30 with the designated name and the other items 30 located nearby from the item table 310. Then, the aggregation management unit 232 causes the list of the extracted items 30 to be displayed in the candidate item area 441.

In the example of FIG. 7, pairs of item IDs and names of four items 30 are displayed together with checkboxes in the candidate item area 441. By the user adding a check to one or more intended candidate items displayed in the candidate item area 441 and operating the add icon 443, these candidate items can be added to the list of constituent items.

The constituent item area 442 is an area for displaying a list of the items constituting the item aggregation being newly registered or edited. In the example of FIG. 7, pairs of item IDs and names of three items 30 are displayed together with checkboxes in the constituent item area 442. By the user adding a check to one or more constituent items displayed in the constituent item area 442 and operating the delete icon 444, these constituent items can be deleted from the list.

When the intended names are set in the aggregation name field 422 and the list of the constituent items displayed in the constituent item area 442 is as intended, the user operates the OK button 451. Then, the aggregation management unit 232 reflects the definition of the item aggregation edited by the user in the item table 310 and the aggregation table 370. For example, in the case of newly registering an item aggregation, a record of a newly assigned aggregation ID is added to the aggregation table 370 and information such as the aggregation name and item number is registered in that record by the aggregation management unit 232. Further, the aggregation management unit 232 updates the fields of Aggregation 317 of records in the item table 310 corresponding to the items 30 constituting the new item aggregation such that they indicate the aggregation ID of the new item aggregation. On the other hand, in the case of editing an item aggregation, the aggregation management unit 232 reflects the changed aggregation name or edited item number in the record of the edited item aggregation of the aggregation table 370. Further, the aggregation management unit 232 reflects the additions and deletions of constituent items of the item aggregation in the fields of Aggregation 317 of the item table 310.

In a case where the user wishes to delete a registration of an existing item aggregation, upon selecting the radio button 413, the user designates the aggregation ID of the target item aggregation in the aggregation ID field 421 (or designates the aggregation name in the aggregation name field 422). Then, the aggregation management unit 232 extracts a list of the items 30 constituting the designated item aggregation from the item table 310 and causes the list to be displayed in the constituent item area 442. Then, when the user operates the OK button 451, the aggregation management unit 232 changes the value of Status 376 of the corresponding record in the aggregation table 370 to “Invalid”, for example, to delete the registration of the item aggregation. At the same time, the aggregation management unit 232 updates the fields of Aggregation 317 of the record in the item table 310 corresponding to the items 30 constituting the deregistered item aggregation with a blank field.

According to the first practical example, the user can add target items 30 reliably and without mistake to a definition of an item aggregation while checking item IDs or names of those items 30 (for example, the IDs or names written on labels attached to the items 30 or on the surfaces of the items 30). For example, the user may register item aggregation data while checking each of the items 30 at a work site where the item aggregations are assembled or packaged each time the operation is complete. Alternatively, the item aggregation data may be collectively registered in a warehouse or a different place 10 where a plurality of items 30 are stored as an item aggregation. In a case where the candidate items are displayed on the basis of results of tag reading, in the reader table 330, only the candidate items based on the results of tag reading by the tag reader 100 associated with a logged in user may be displayed on the screen and be made selectable as a constituent item. These also apply to the other practical examples.

Note that in the example described above, data is input via a graphical user interface (GUI). However, data may be input via an audio UI using a speaker and a microphone. Alternatively, instead of specifying a candidate item on the basis of results of tag reading by the tag reader 100, a candidate item that can be added to an item aggregation may be specified by a code reader reading a visible code such as a barcode attached to the surface of each item.

### (2) Second Practical Example

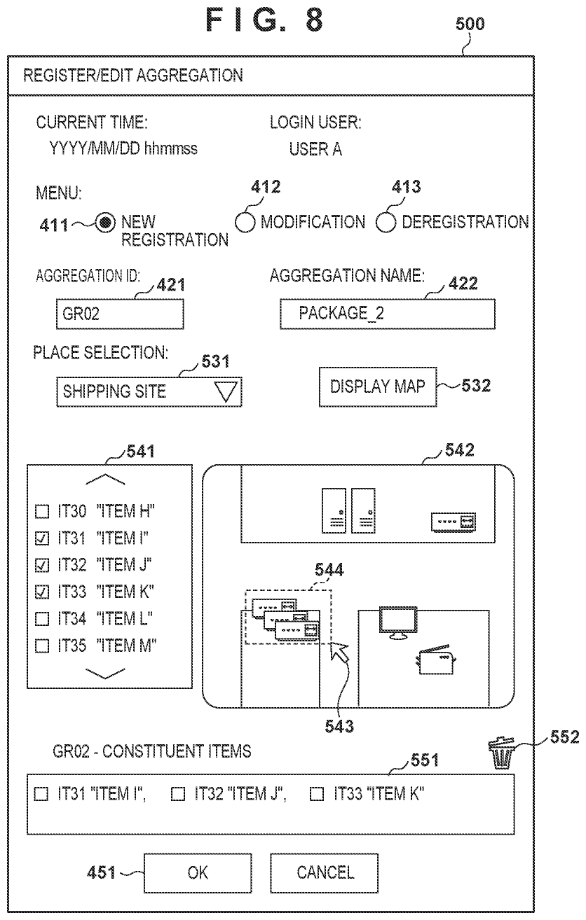

In the second practical example, the aggregation management unit 232 causes an aggregation management screen 500 (hereinafter, simply referred to as screen 500) illustrated in FIG. 8 to be displayed on the display of the user terminal 300. The screen 500 is screen that displays detection positions of items 30 based on results of tag reading by the tag reader 100 on a map image of a place 10 where the tag reader 100 is used. The screen 500 may be a web screen or may be an application screen displayed by a dedicated application, too. The screen 500 may be displayed after successful login authentication for the item management system 1.

The aggregation management screen 500 includes the radio buttons 411, 412, and 413 and the aggregation ID field 421 and the aggregation name field 422, which are screen elements described in connection with the aggregation management screen 400 of FIG. 7.

The screen 500 further includes a place selection field 531, a map display button 532, a candidate item area 541, a map display area 542, a constituent item area 551, a delete icon 552, and the OK button 451.

In the case of newly registering an item aggregation, the user selects a place 10 where items 30 constituting an item aggregation exists in the place selection field 531 and operates the map display button 532. Then, the aggregation management unit 232 extracts a list of the items 30 (candidate items) that exist in the selected place 10 from the item table 310 and causes the list of extracted items 30 to be displayed in the candidate item area 541. Also, the aggregation management unit 232 causes the map image of the selected place 10 to be displayed in the map display area 542 on the basis of the map image data obtained from the place table 320 and overlays item icons representing the candidate items on the map image. The aggregation management unit 232, for example, may overlay a different item icon on the map image depending on the type of each candidate item indicated by Type 314 of the item table 310. In the example of FIG. 8, a plurality of items 30 including “Item H” to “Item M” that exist at “Shipping Site” are candidate items, and at least four types of item icons corresponding to these candidate items are displayed in the map display area 542 overlaid on the map image of “Shipping Site”.

The user, for example, performs a drag operation with a pointer 543 to enclose item icons of intended candidate items in a drag region 544 in the map display area 542 to designate the candidate items to be added to the list of the items constituting the item aggregation. The drag region 544, for example, may be a rectangular region set on the basis of a start point and an end point of the drag operation. Instead of dragging, the user may touch or click the item icons of the intended candidate items to designate the constituent items to be added to the list of the constituent items. In the example of FIG. 8, the result of dragging the pointer 543 includes “Item I”, “Item J”, and “Item K” in the drag region 544. Thus, these three items 30 are selected as constituent items and displayed in the constituent item area 551. By the user adding a check to one or more constituent items displayed in the constituent item area 551 and operating the delete icon 552, these constituent items may be deleted from the list.

In the case of editing an item aggregation, a place where an existing item aggregation having the aggregation ID designated in the aggregation ID field 421 or the aggregation name designated in the aggregation name field 422 exists is automatically selected in the place selection field 531. Then, when the map display button 532 is operated, the aggregation management unit 232 causes the list of the items 30 that exist at the place 10 automatically selected to be displayed in the candidate item area 541 and causes the map image of this place to be displayed in the map display area 542 together with item icons. Further, the aggregation management unit 232 causes the list of the items 30 constituting the designated existing item aggregation to be displayed in the constituent item area 551. Here, the user may designate items 30 to be added to the item aggregation in the map display area 542, too. Also, by the user adding a check to one or more of the items 30 in the constituent item area 551 and operating the delete icon 552, these items 30 may be deleted from the list of constituent items.

When the user operates the OK button 451, the aggregation management unit 232 reflects the definition of the item aggregation edited by the user in the item table 310 and the aggregation table 370.

According to the second practical example, the user 20 can appropriately define an item aggregation constituted by intended constituent items 30 while visually checking the latest positional relationship between the items 30 on the map image on the basis of results of tag reading by the tag reader 100.

### (3) Third Practical Example

In the third practical example, the aggregation management unit 232 may register item aggregation data in the item DB 220 on the basis of a data file generated by the user 20 or the system administrator. For example, the aggregation management unit 232 causes a simple file dialog to be displayed on the display of the management server 200 or the user terminal 300 and accepts input of the data file via the displayed file dialog. The input data file may include contents of one or more records to be added to the aggregation table 370 as described using FIG. 6 and a list of item IDs of multiple items 30 associated with each aggregation ID. In accordance with descriptions in the data file, the aggregation management unit 232 adds item aggregation records to the aggregation table 370 and updates fields of Aggregation 317 of the item table 310.

By incorporating the function of batch registration of item aggregation data based on a data file in this manner, definitions of a plurality of item aggregations can be registered in the item DB 220 in a short time.

### 3-4-4. Tracking Position as Item Aggregation

In a case where the tag reader 100 detects at least M item tags 50 from among the item tags 50 attached to N items 30 constituting one item aggregation, the aggregation management unit 232 updates the position information of the N items 30 according to the item aggregation data. Here, M is an integer smaller than N.

Specifically, when the relationship between the detection positions of the item tags 50 of at least M items 30 detected by the tag reader 100 satisfies a predetermined condition, the aggregation management unit 232 may update the position information of the N items 30 belonging to the same item aggregation. The predetermined condition includes, for example, the tag reader 100 detecting at least M item tags 50 within a time period no greater than a predetermined duration and no distance between the detection positions of these item tags 50 being greater than a preset distance threshold.

Note that updating the position information of N items 30 included in the item aggregation may include at least one of updating the position information associated with each of the N items 30 and updating the position information associated with the item aggregation. For example, the position information associated with each item 30 may include one or both of Place 315 and Coordinates 316 of each item 30 stored in the item table 310. The position information associated with the item aggregation may include Place 375 of one item aggregation stored in the aggregation table 370. Note that the aggregation table 370 may further include a data element representing coordinates indicating a representative position of each item aggregation (for example, the position of any one constituent item or the centroid position between the positions of a plurality of constituent items).

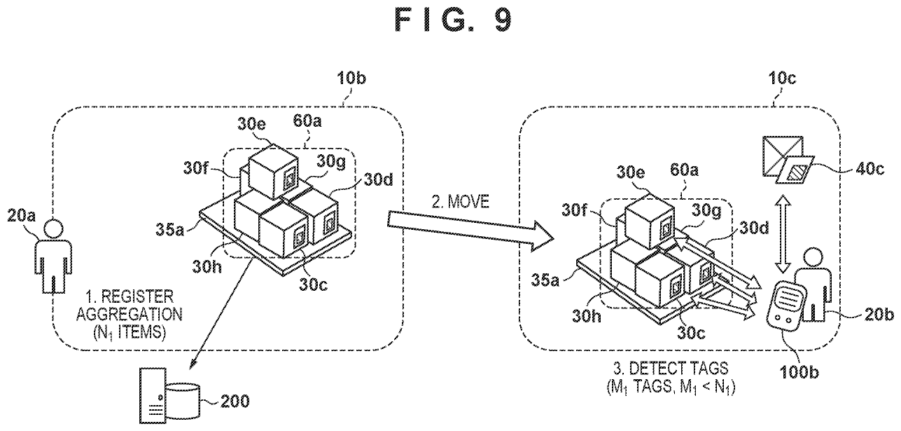

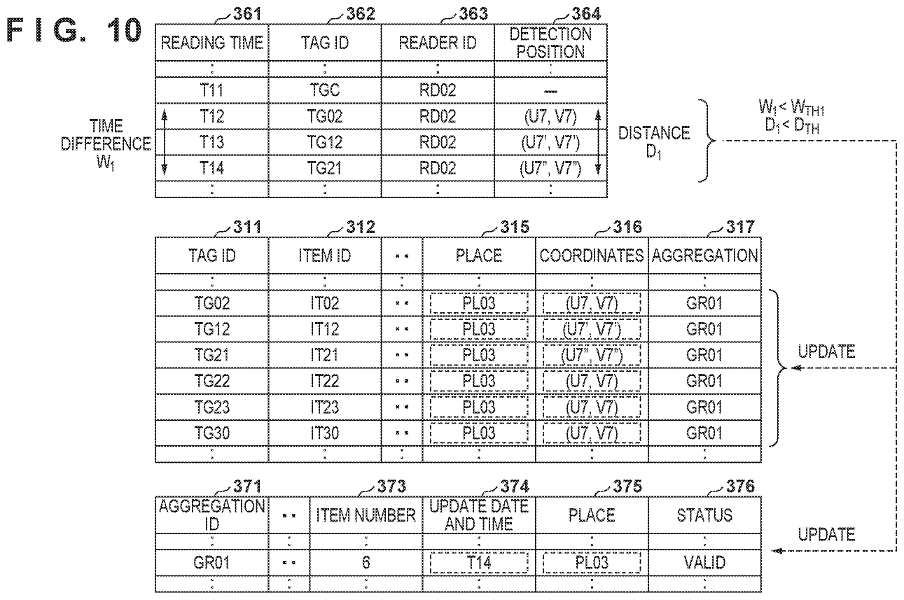

Tracking position in an item aggregation following a representative scenario will now be more specifically described using FIGS. 9 and 10. On the left in FIG. 9, the items 30c, 30d, 30e, 30f, 30g, and 30h stacked on the pallet 35a existing in the place 10b are illustrated. The user 20a registers the item aggregation 60a consisting of these N₁ (N₁=6) items 30 in the item DB 220. The item aggregation 60a is identified by an aggregation ID “GR01”, for example.

Thereafter, for example, the user 20b transports the pallet 35a and moves the items 30c, 30d, 30e, 30f, 30g, and 30h to the place 10c. The user 20b is carrying the tag reader 100b. The tag reader 100b detects the position tag 40c installed at the place 10c and the item tags 50 of the M₁ (M₁<N₁) items 30 constituting the item aggregation 60a. In the example on the right of FIG. 9, M₁=3, where the item tags 50 of the items 30c, 30d, and 30e are detected by the tag reader 100b.

FIG. 10 illustrates how the item aggregation data in the item DB 220 is updated by the aggregation management unit 232 in the scenario described above. According to the tag detection table 360 illustrated in the upper level of FIG. 10, first, at the reading time “T11”, the position tag 40c identified by a tag ID “TGC” is detected by the tag reader 100b identified by a reader ID “RD02”. Thereafter, at the reading times “T12”, “T13”, and “T14”, the three item tags 50 identified by tag IDs “TG02”, “TG12”, and “TG21”, respectively, are detected by the same tag reader 100b. These item tags 50 are attached to the items 30c, 30d, and 30e, respectively. A time difference W₁ between the reading times “T12” and “T14” is less than a predetermined duration W_{TH1} (W₁<W_{TH1}), and a maximum distance D₁ between the detection positions of the items 30c, 30d, and 30e is less than a distance threshold D_{TH} (D₁<D_{TH}).

The aggregation management unit 232 determines that the results of tag reading received from the tag reader 100b satisfy a condition for updating the position information of the item aggregation 60a and starts a collective update of the position information. In the middle level of FIG. 10, how the item table 310 is updated is illustrated. The values of Place 315 for six records associated with the aggregation ID “GR01” are updated to the place ID “PL03” identifying the place 10c. Also, the values of Coordinates 316 of the items 30c, 30d, 30e actually detected by the tag reader 100b are changed with the coordinates of the actual detection position, and the values of Coordinates 316 of the remaining items 30f, 30g, and 30h that belong to the same item aggregation 60a but were undetected are updated with a representative value. In the lower level of FIG. 10, how the aggregation table 370 is updated is illustrated. The value of Update Date and Time 374 of the record for the aggregation ID “GR01” is updated with the date and time at which update is performed, and the value of Place 375 is updated with the place ID “PL03” identifying the place 10c.

In this manner, in the present embodiment, even when item tags 50 of some of items 30 that constitutes an item aggregation defined in advance are not detected, the position information of the undetected items 30 are updated on the basis of the detection results of the item tags 50 of the remaining items 30. Thus, the user 20 is not forced to perform a cumbersome operation such as hold the tag reader 100 up to the item aggregation at various angles to collectively read the tag IDs each time the item 30 is moved.

### 3-4-5. Canceling Definition of Item Aggregation

In a case where a distance between detection positions of two or more item tags 50 detected by the tag readers 100 within a predetermined time period from among item tags 50 attached to items 30 constituting a certain item aggregation is greater than a distance threshold, the aggregation management unit 232 cancels the definition of the item aggregation including the N items. The distance threshold here may be equal to the threshold D_{TH} described above or may be different.

As an example, by attaching a flag indicating that the item aggregation data is invalid (changing the value of Status 376 of the aggregation table 370 to “Invalid”), the aggregation management unit 232 may cancel the definition of the item aggregation. As another example, by deleting the item aggregation data (deleting the record from the aggregation table 370 and changing the fields of Aggregation 317 of the item table 310 to a blank field), the aggregation management unit 232 may cancel the definition of the item aggregation. As yet another example, by excluding one or more of the items from the definition of the item aggregation, the aggregation management unit 232 may cancel the definition of the item aggregation including the N items and redefine the item aggregation including a fewer number of constituent items.

In a case where the condition described above for canceling a definition of an item aggregation is satisfied, the aggregation management unit 232 may make an inquiry to the user 20 as to whether or not to cancel the definition of the item aggregation and may cancel the definition of the item aggregation including the N items only when the user 20 selects to cancel the definition. Meanwhile, when the user 20 selects not to cancel the definition of the item aggregation, the aggregation management unit 232 may refrain from canceling the definition of the item aggregation. In this manner, by asking the user 20 to select or consent to canceling the definition, it is possible to prevent a definition of an item aggregation from being canceled against an intention of the user 20 when one or a small number of the items 30 has fallen from the item aggregation by an accident. In a case where the user 20 rejects canceling the definition upon an inquiry being made and the fallen item 30 is returned to the original position of the item aggregation, thereafter, no more inquiries are made relating to canceling the definition of the item aggregation, allowing the definition of the item aggregation to be maintained. The aggregation management unit 232 may provide the user with a selectable option to invalidate an existing item aggregation or to exclude only one or more constituent items and redefine the item aggregation in the UI for the inquiry to the user 20 as to whether or not to cancel the definition of the item aggregation (for example, an inquiry screen).

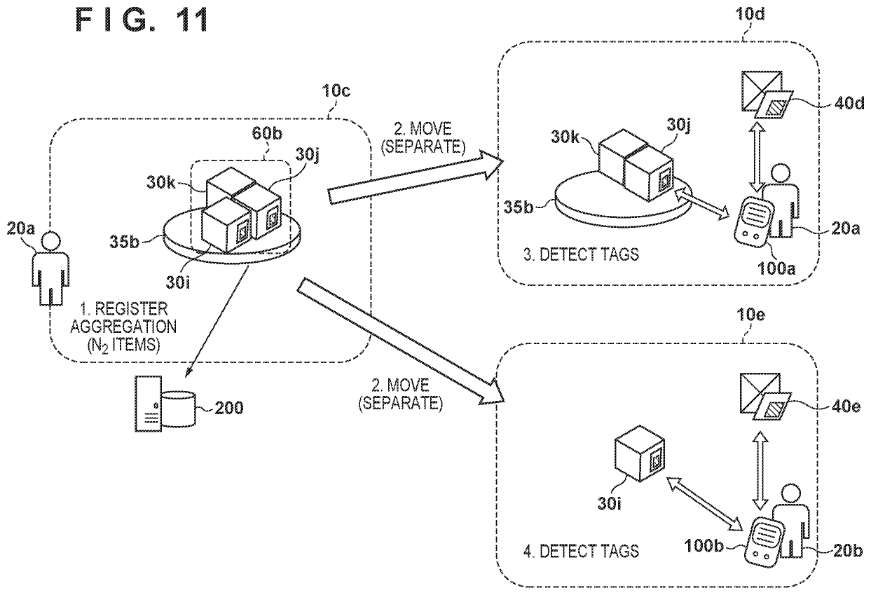

Canceling a definition of an item aggregation following a representative scenario will now be more specifically described using FIGS. 11 to 13. On the left in FIG. 11, items 30i, 30j, and 30k stacked on a pallet 35b existing in the place 10c are illustrated. The user 20a registers an item aggregation 60b consisting of these N₂ (N₂=3) items 30 in the item DB 220. The item aggregation 60b is identified by an aggregation ID “GR02”, for example.

Thereafter, for example, the user 20a transports the pallet 35b to a place 10d. However, only the items 30j and 30k are stacked on the pallet 35b which is in the place 10d after transport, and for some reason the item 30i has moved to a place 10e. The tag reader 100a of the user 20a at the place 10d detects a position tag 40d installed at the place 10d and the item tags 50 of the items 30j and 30k. Also, the tag reader 100b of the user 20b at the place 10e detects a position tag 40e installed at the place 10e and the item tag 50 of the item 30i.

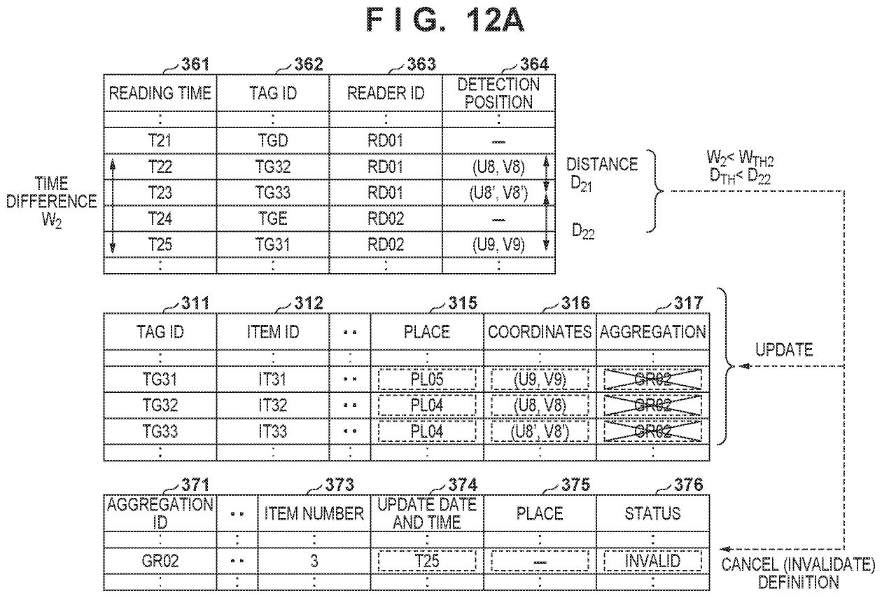

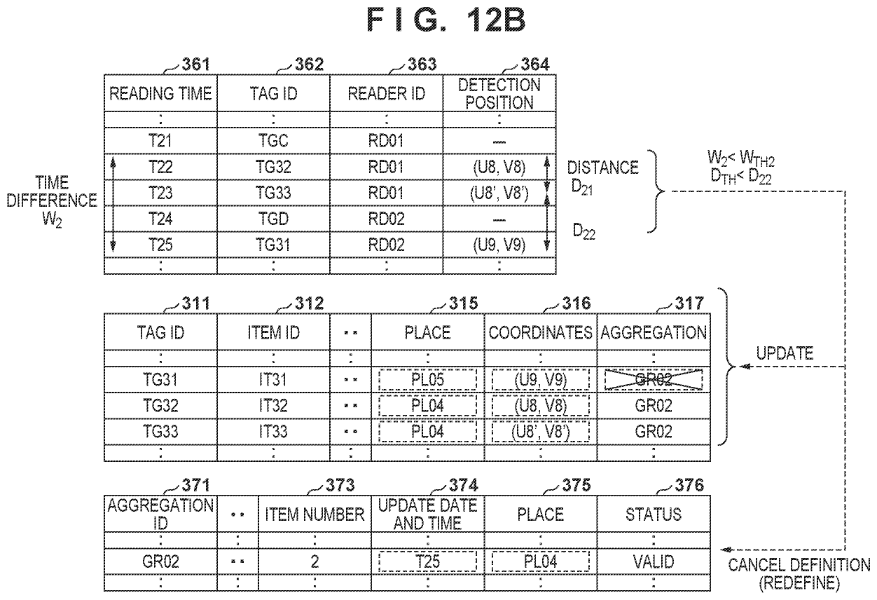

FIG. 12A illustrates an example of how the item aggregation data in the item DB 220 is updated by the aggregation management unit 232 in the scenario described above. According to the tag detection table 360 illustrated in the upper level of FIG. 12A, first, at the reading time “T21”, the position tag 40d identified by a tag ID “TGD” is detected by the tag reader 100a identified by a reader ID “RD01”. Thereafter, at the reading times “T22” and “T23”, the two item tags 50 identified by tag IDs “TG32” and “TG33”, respectively, are detected by the same tag reader 100a. These item tags 50 are attached to the items 30j and 30k, respectively. Also, at the reading time “T24”, the position tag 40e identified by a tag ID “TGE” is detected by the tag reader 100b identified by a reader ID “RD02”. Thereafter, at the reading time “T25”, the item tag 50 identified by a tag ID “TG31” is detected by the same tag reader 100b. This item tag 50 is attached to the item 30i. A time difference W₂ between the reading times “T22” and “T25” is shorter than a predetermined duration W_{TH2} (W₂<W_{TH2}). A distance D₂₁ between the detection position of the item 30j and the detection position of the item 30k is less than the distance threshold D_{TH}, but a distance D₂₂ between the detection position of the item 30i and the detection position of the item 30k is greater than the distance threshold D_{TH} (D₂₁<D_{TH}<D₂₂).

The aggregation management unit 232 determines that the results of tag reading received from the two tag readers 100 satisfy a condition for canceling the definition of the item aggregation 60b. In the middle level of FIG. 12A, how the item table 310 is updated in this case is illustrated. The fields of Aggregation 317 for three records associated with the aggregation ID “GR02” are changed to blank fields. Also, the values of Place 315 and Coordinates 316 of each record are updated to reflect the latest tag reading results. In the lower level of FIG. 12A, how the aggregation table 370 is updated is illustrated. The value of Update Date and Time 374 of the record for the aggregation ID “GR02” is changed to the date and time at which update is performed, the field of Place 375 is changed to a blank field, and the value of Status 376 is changed to “Invalid”.

FIG. 12B illustrates another example of how the item aggregation data in the item DB 220 is updated by the aggregation management unit 232 in the same scenario as FIG. 12A. The contents of the tag detection table 360 illustrated in the upper level of FIG. 12B are similar to the contents illustrated in FIG. 12A. Since a distance between the detection positions of the items 30i, 30j, and 30k detected with the time difference W₂ shorter than the duration W_{TH2} is greater than the distance threshold D_{TH} (D_{TH}<D₂₂), the aggregation management unit 232 determines that the condition for canceling the definition of the item aggregation 60b is satisfied. In the middle level of FIG. 12B, how the item table 310 is updated in this case is illustrated. The fields of Aggregation 317 for the record of the item 30i associated with the aggregation ID “GR02” (identified by the tag ID “TG31”) is changed to a blank field. On the other hand, in the example of FIG. 12B, the values of Aggregation 317 of the records for the items 30j and 30k (identified by the tag IDs “TG32” and “TG33”, respectively) are unchanged with “GR02” for the aggregation ID. Also, the values of Place 315 and Coordinates 316 of these three records are updated to reflect the latest tag reading results. In the lower level of FIG. 12B, how the aggregation table 370 is updated is illustrated. The value of Item Number 373 of the record for the aggregation ID “GR02” is changed to “2”, the value of Update Date and Time 374 is change to the date and time when update is performed, and the value of Place 375 is changed to “PL04”. That is, in the example of FIG. 12B, the definition of the item aggregation 60b including the three items 30 is canceled, and the item aggregation 60b is redefined as an aggregation including the two items 30. Note that redefining an item aggregation may be performed by invalidating an existing item aggregation and adding a record of a new item aggregation to the aggregation table 370.

In this manner, in the present embodiment, in a case where one or more constituent items of an item aggregation is detected at a position separated from detection positions of the other constituent items, it can be automatically determined that the aggregation has been broken up, and the definition of the original item aggregation is canceled (after obtaining a consent of a user 20 as necessary). Thus, the item aggregation data is easily adapted to the actual movement statuses of the items 30, and the necessity for the user 20 to actively modify the item aggregation data is mitigated.

### 3-4-6. Various Settings

The setting unit 233 sets various parameters for the item management described above. For example, the parameters set by the setting unit 233 include one or more of the following:
Number M: the minimum number of constituent items to be detected for tracking position in an item aggregation
Distance threshold D_{TH}: The threshold compared to distances between the detection positions of constituent items for determining whether to maintain or cancel a definition of an item aggregation
Duration W_{TH1}: The duration of a time period for counting the number M
Duration W_{TH2}: The duration of a time period for the condition for canceling a definition of an item aggregation. W_{TH2} may be equal to or different from WITH (for example, W_{TH2} may be set to a value greater than W_{TH1}).

The setting unit 233 may set each of the parameters described above to a common value irrespective of the item aggregation or to a different value for each item aggregation. For example, the setting unit 233 may set the setting value for parameter M for each item aggregation on the basis of the number N of the constituent items of the item aggregation (for example, M=N−1 or M=N/2).

The value of each parameter may be variably set by the user. The setting unit 233 may cause a settings screen for accepting an input of a value of each parameter to be displayed on the display of the user terminal 300 and may set each parameter to the value input by the user 20 on the settings screen. For example, the user using the system in an environment where there is a higher possibility of the propagation paths of the electromagnetic waves being obstructed can set the parameter M to a lower value to more proactively update the collective position information in an item aggregation, allowing the cumbersomeness of position tracking to be reduced. Also, by the user setting the distance threshold D_{TH} to match the physical size of an item aggregation being handled (for example, setting D_{TH} higher when the size of the expected item aggregation is larger), the possibility of an error in the determination relating to breaking up the item aggregation can be reduced.

### 3-5. Position Information Inquiry

The information provision unit 234 provides a user 20 with information maintained by the item DB 220. For example, the information provision unit 234 may provide the position information of the items 30 individually tracked by the position management unit 231 or collectively tracked as an item aggregation by the aggregation management unit 232 to the user 20 on the display of the user terminal 300.

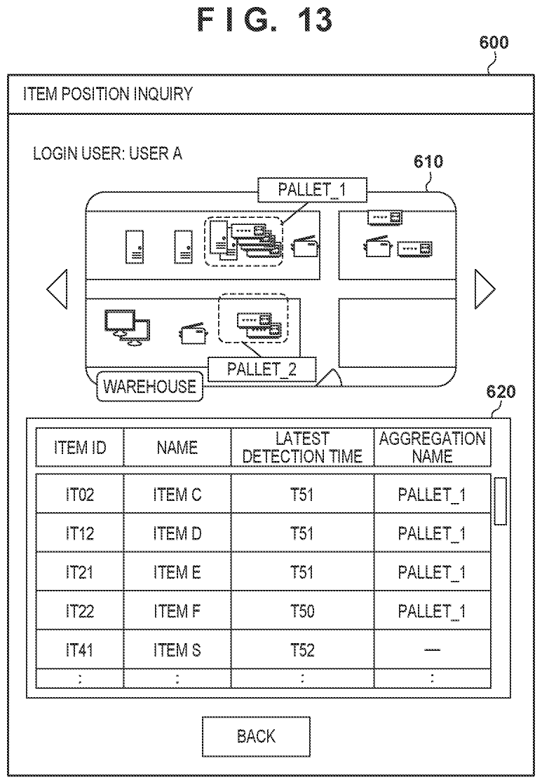

FIG. 13 illustrates an example of an inquiry screen 600 that may be displayed on the display of the user terminal 300 for providing position information to the user 20. Here, the user 20a using the user terminal 300 is logging into the system and inquiring about the position information. In the upper portion of the screen, the login user name “User A” is displayed. The inquiry screen 600 includes a map display area 610 and an item list display area 620. The map display area 610 is an area for displaying a map image of a place selected by the login user from among the places 10 permitted for viewing overlaid with item icons representing items 30 existing in the selected place. In the example of FIG. 13, the place 10b (that is, a “Warehouse”) is selected as the target for viewing. In the map display area 610, together with the map image of the place 10b, item icons of several items 30 detected in the place 10b are displayed in a manner that they are overlaid at their detection positions. The information provision unit 234 may overlay different item icons on the map image depending on the type of each item 30 indicated by Type 314 of the item table 310. The item list display area 620 is an area for displaying data relating to the items 30 existing in the selected place in a table format. In the example of FIG. 13, for each item 30, Item ID, Name, Latest Detection Time, and Aggregation Name of the item aggregation to which each belongs are display in the item list display area 620.

The information provision unit 234 may control the display of position information in the map display area 610 in a manner that items 30 constituting an item aggregation can be discerned, for example. In the example of FIG. 13, in the map display area 610, a broken line frame surrounding items 30 constituting each item aggregation and a caption text indicating its aggregation names are displayed. Even if a constituent item of such an item aggregation is not detected by a tag reader 100, the constituent item is recognized at approximately the correct position as a result of other M constituent items belonging to the same item aggregation been detected, and the resulting position information is provided to the user 20.

Note that the inquiry screen 600 illustrated in FIG. 13 is merely an example of a screen for providing the position information to the user 20. The information provision unit 234 may provide the position information to the user 20 via a screen with any other configuration. The information provision unit 234 may provide the position information to the user 20 by causing speech based on the position information to be output from the speaker of the user terminal 300. The information provision unit 234 may provide the position information of the items 30 (for example, in a data file format) tracked via the mechanism according to the present embodiment to another system or a certain application cooperating with the item management system 1.

### 4. Process Flow

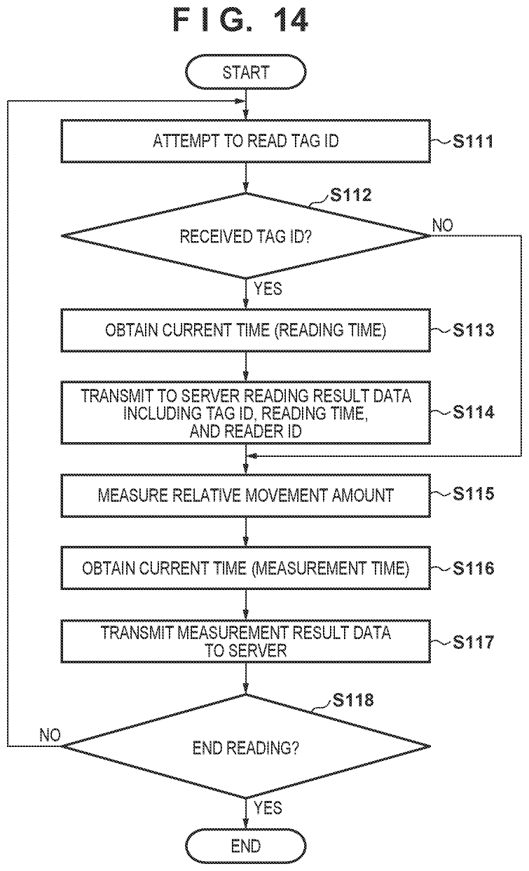

In the present segment, an example of the flow of some processes that may be performed in the item management system 1 will be described using the flowcharts of FIGS. 14 to 17. Note that in the following description, process step is shortened to S (step).

<4-1. Tag Reading Process (Tag Reader)>

FIG. 14 is a flowchart illustrating an example of a flow of a tag reading process performed by the tag reader 100. The tag reading process of FIG. 14 may be started in response to the tag reader 100 being activated or a certain user operation on the tag reader 100.

First, in S111, the reading unit 106 emits electromagnetic waves to a tag-reading range to attempt reading tag IDs from nearby RFID tags. When the tag reading attempt results in a tag ID being received from a nearby RFID tag utilizing energy of electromagnetic waves (Yes in S112), the process proceeds to S113. On the other hand, when no tag ID is received (No in S112), the process proceeds to S115.

When a tag ID is received, in S113, the control unit 101 references the internal real-time clock, for example, to obtain the current time as the reading time for the tag ID. Next, in S114, the control unit 101 transmits the reading result data including the read tag ID, the reading time, and the reader ID of the tag reader 100 to the management server 200 via the communication unit 103. Then the process proceeds to S115.

Note that though not illustrated in FIG. 14, the control unit 101 may request the detected RFID tag to transmit information other than the tag ID and may further receive the information sent back from the RFID tag. In this case, the control unit 101 may transmit the reading result data additionally including the received information to the management server 200 in S114.

In S115, the measuring unit 104 measures an amount of relative movement of the tag reader 100 on the basis of sensor data output from the three-axis acceleration sensor, the gyro sensor, and the geomagnetic sensor, for example. Next, in S116, the control unit 101 obtains the current time as the measurement time. Then, in S117, the control unit 101 transmits the measurement result data including the amount of relative movement measured by the measuring unit 104, the measurement time, and the reader ID of the tag reader 100 to the management server 200 via the communication unit 103.

Next, in S118, the control unit 101 determines whether or not to end the tag reading process. For example, in a case where a user operation instructing to end reading is detected, the tag reading process is ended. Otherwise, S111 to S117 described above may be repeated again.

<4-2. Aggregation Registration/Edit Process (Management Server)>

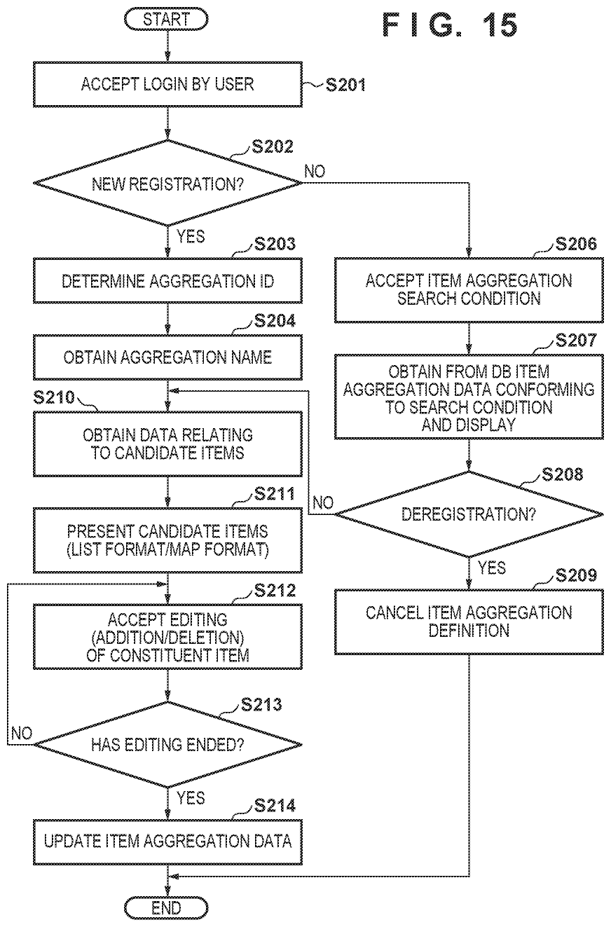

FIG. 15 is a flowchart illustrating an example of a flow of an aggregation registration/edit process performed by the management server 200. The aggregation registration/edit process of FIG. 15, for example, may be performed when the user 20 accesses the aggregation management screen 400 or 500 provided by the aggregation management unit 232 of the management server 200 using the user terminal 300.

First, in S201, the aggregation management unit 232 accepts a login from a user and causes the called aggregation management screen (for example, in response to successful user authentication) to be displayed on the display of the user terminal 300.

At S202, the subsequent process branches depending on whether or not newly register an item aggregation is selected as the edit menu. In a case where newly register an item aggregation is selected, the process proceeds to S203. On the other hand, in a case where a selection is made to modify or delete registration of an existing item aggregation, the process proceeds to S206.

In a case where new registration is selected, in S203, the aggregation management unit 232 determine an aggregation ID for uniquely identifying the new item aggregation. Next, in S204, the aggregation management unit 232 obtains a name of the new item aggregation input by the user. Then, the process proceeds to S210.

In a case where the selection is made to modify or delete registration of an existing item aggregation, in S206, the aggregation management unit 232 accepts the input of a search condition for searching for the item aggregation to be edited in the item DB 220. Here, the input search condition may include any condition such as a condition that designates an aggregation ID or aggregation name, for example. Next, in S207, the aggregation management unit 232 obtains item aggregation data that conforms to the search condition accepted in S206 from the item DB 220. Then, the aggregation management unit 232 causes information such as the aggregation ID and aggregation name of the item aggregation to be edited and a list of constituent items to be displayed on the screen on the basis of the obtained item aggregation data.

At S208, the subsequent process branches depending on whether or not deregistration of an item aggregation is selected as the edit menu. In a case where deregistration of an item aggregation is selected, the process proceeds to S209. On the other hand, in a case where modification to an item aggregation is selected, the process proceeds to S210.

In a case where deregistration of an item aggregation is selected, in S209, the aggregation management unit 232 cancels the definition of the item aggregation being edited (in response to the operation of the OK button 451, for example). Canceling the definition of the item aggregation here may include invalidating or deleting a record of the aggregation table 370 and deleting values of Aggregation 317 for records of the items 30 belonging to the item aggregation being edited in the item table 310, for example.

In the case of new registration or editing, in S210, the aggregation management unit 232 obtains data relating to candidate items that can be added to the list of constituent items from the item DB 220. As an example, the aggregation management unit 232 may obtain data (for example, item ID, item name, and detection position) relating to one or more of the items 30 detected in a designated time period by the designated tag reader 100. As another example, the aggregation management unit 232 may obtain data relating to a designated reference item and the other items 30 located close to the reference item. Next, in S211, the aggregation management unit 232 presents the candidate items that can be added to the list of constituent items to the user in a list format (see FIG. 7) or a map format (see FIG. 8) on the basis of the data obtained in S210.

Next, in S212, the aggregation management unit 232 accepts, on the screen, editing (adding or deleting) of the constituent item to be newly registered or edited. For example, the user may select the intended item 30 from the presented candidate items and add the item 30 to the list of constituent items or may select an item 30 to be deleted in the list of constituent items and delete the item 30 from the list. Accepting editing of a constituent item may continue until, in S213, the aggregation management unit 232 determines that the user has ended editing (in response to the operation of the OK button 451, for example). When the aggregation management unit 232 determines that editing has been ended by the user, the process proceeds to S214.

In S214, the aggregation management unit 232 updates the item aggregation data in the item DB 220 such that it reflects the result of the editing accepted in S212 is applied. For example, in the case of a new registration, the aggregation management unit 232 adds a record for the new item aggregation to the aggregation table 370 and changes the values of Aggregation 317 for the records in the item table 310 that correspond to the constituent items of the new item aggregation to an aggregation ID for the new constituent item. Also, in the case of editing an existing item aggregation, the aggregation management unit 232 applies the changed aggregation name and the number of constituent items after the editing in the corresponding record in the aggregation table 370 and reflects the addition or deletion of constituent items of the item aggregation to the fields of Aggregation 317 in the item table 310.

When the update of the item aggregation data in the item DB 220 is complete, the aggregation registration/edit process of FIG. 15 ends.

<4-3. Data Reception Process (Management Server)>

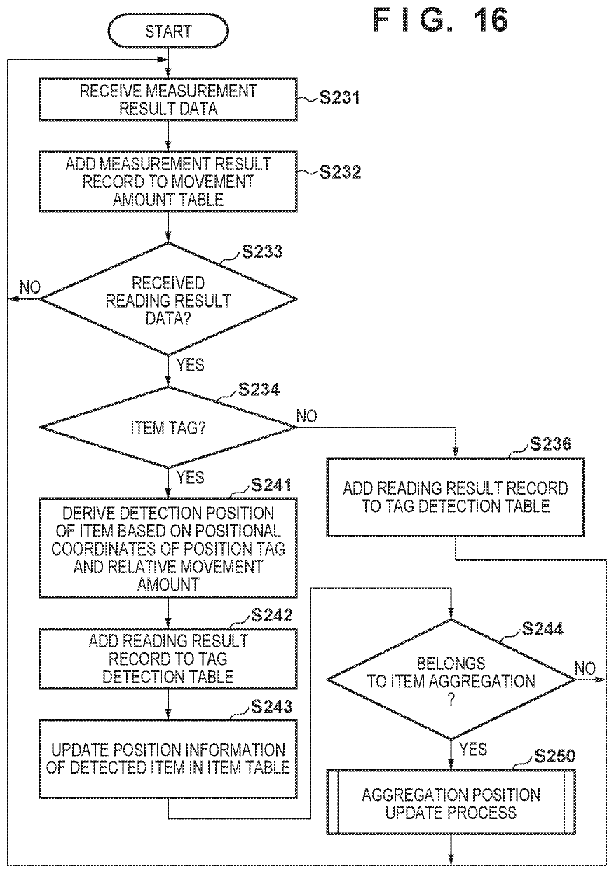

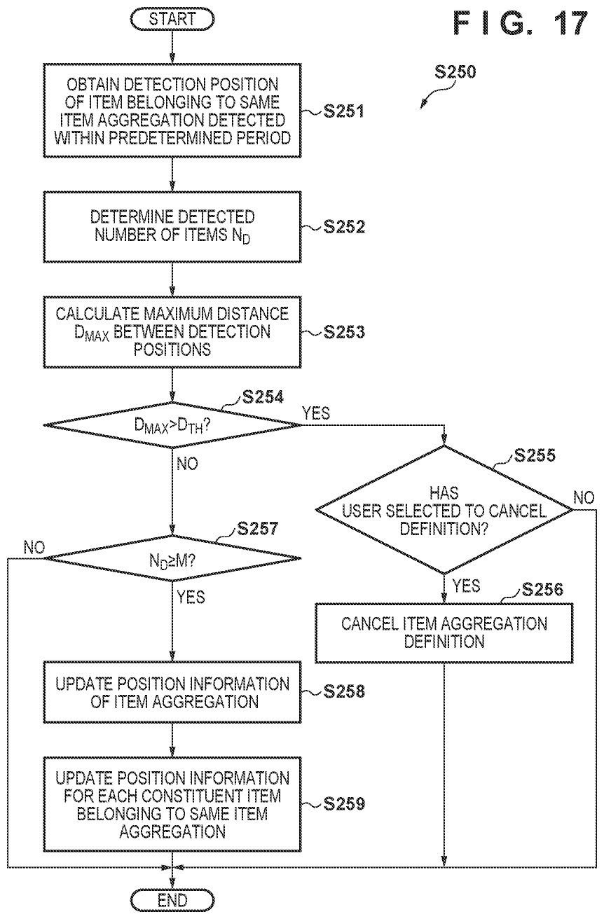

FIG. 16 is a flowchart illustrating an example of a flow of the data reception process performed by the management server 200. The data reception process of FIG. 16 may be periodically repeated while the item management function of the management server 200 is operating.

First, in S231, the position management unit 231 of the management server 200 receives measurement result data transmitted periodically from the tag reader 100. Next, in S232, the position management unit 231 adds, to the movement amount table 350, a measurement result record including the measurement time, reader ID, and movement amount indicated by the received measurement result data.

While S231 and S232 are repeated, in S233, the position management unit 231 waits to receive reading result data from the tag reader 100. When the reading result data is received from the tag reader 100, the process proceeds to S234. In S234, the process branches depending on whether the position tag 40 or the item tag 50 has been detected by the tag reader 100. In a case where the position tag 40 has been detected by the tag reader 100 (reading result data has been received for the position tag 40), the process proceeds to S236. On the other hand, in a case where the item tag 50 has been detected by the tag reader 100 (reading result data has been received for the item tag 50), the process proceeds to S241.

In S236, the position management unit 231 adds, to the tag detection table 360, a reading result record including the reading time, tag ID, and reader ID indicated by the reading result data for the detected position tag 40. Then, the process returns to S231.

In S241, the position management unit 231 derives the detection position of the detected item 30 on the basis of the amount of relative movement of the tag reader 100 at the reading time (that is, the detection time) indicated by the reading result data for the detected item tag 50. For example, the position management unit 231 calculates sum of the amount of relative movement of the tag reader 100 from the point where a position tag 40 has been detected and the known positional coordinates of the detected position tag 40, and thereby derives the detection position of the detected item 30. Note that S241 may be omitted until a position tag 40 is detected for the first time after the tag reader 100 is activated. Next, in S242, the position management unit 231 adds the reading result record including the reading time, tag ID, reader ID, and detection position derived in S241 of the detected item tag 50 to the tag detection table 360. Next, in S243, the position management unit 231 updates the position information (for example, the values for Place 315 and Coordinates 316) in the item table 310 for the detected item 30.

Next, in S244, the position management unit 231 determines whether the detected item 30 belongs to an item aggregation by referencing the item table 310. In a case where the detected item 30 belongs to an item aggregation, the position management unit 231 calls the aggregation management unit 232 and causes the aggregation management unit 232 to perform the aggregation position update process of S250. In a case where the detected item 30 does not belong to an item aggregation, the aggregation position update process of S250 is skipped, and the process returns to S231.

<4-4. Aggregation Position Update Process (Management Server)>

FIG. 17 is a flowchart illustrating an example of a flow of the aggregation position update process performed by the management server 200. The aggregation position update process of FIG. 17 may be performed in S250 of the data reception process of FIG. 16.

First, in S251, the aggregation management unit 232 obtains, from the tag detection table 360, detection positions of items 30 belonging to the same item aggregation detected by the tag reader 100 within a predetermined time period. The predetermined time period here may be a time period with the reading time of the item 30 last detected as the end point and a duration correspond to the duration W_{TH1} set by the setting unit 233. Here, it is assumed that W_{TH1}=W_{TH2}. Next, in S252, the aggregation management unit 232 determines a number ND of the items 30 (belonging to the same item aggregation) detected within the predetermined time period. In addition in S253, the aggregation management unit 232 calculates a maximum distance D_{MAX} between the detection positions of the items 30 obtained in S251.

Next, in S254, the aggregation management unit 232 determines whether the maximum distance D_{MAX} calculated in S253 is greater than the distance threshold D_{TH} set by the setting unit 233. In a case where D_{MAX} is greater than D_{TH}, there is a possibility that the item aggregation has been broken up, and thus the process proceeds to S255. In a case where D_{MAX} is less than D_{TH}, the process proceeds to S257.

In S255, the aggregation management unit 232 makes an inquiry to the user 20 via the user interface of the user terminal 300 as to whether or not to cancel the definition of the item aggregation. For example, the aggregation management unit 232 may cause the display of the user terminal 300 to display one or more of: aggregation ID, aggregation name, and list of constituent items of the item aggregation at issue, and item ID, item name, and detection position of a constituent item that may have fallen. The user 20 selects whether or not to cancel the definition of the item aggregation in response to the inquiry. In a case where the user 20 selects to cancel the definition of the item aggregation, in S256, the aggregation management unit 232 cancels the definition of the item aggregation in the item DB 220 (for example, invalidates the definition, redefines with a smaller number of constituent items, or deletes the record). On the other hand, in a case where the user 20 selects not to cancel the definition of the item aggregation, S256 is skipped, and the aggregation position update process of FIG. 17 ends.

In S257, the aggregation management unit 232 determines whether the number ND of the items 30 in the same item aggregation determined in S252 is equal to or greater than the number M set by the setting unit 233. In a case where the number ND is less than M, the aggregation position update process of FIG. 17 ends without tracking of positions as an item aggregation being performed. In a case where the number ND is equal to or greater than M, the process proceeds to S258.

In S258, the aggregation management unit 232 determines to perform tracking of positions as an item aggregation and updates the position information (for example, the value of Place 375 of the corresponding record of the aggregation table 370) of the item aggregation. Also, in S259, the aggregation management unit 232 updates the position information (for example, the values of Place 315 and Coordinates 316 for the record of each constituent item in the item table 310) for each constituent item belonging to the same item aggregation. Then the aggregation position update process of FIG. 17 ends.

### 5. Summary

Various embodiments and practical examples of the technology according to the present disclosure have been described above in detail using FIGS. 1 to 17. According to the embodiments described above, in an item management system, position information of a plurality of items is stored in a database. A wireless device storing identification information is attached to each item. A reading apparatus reads the identification information from the wireless device, and the position information of the item is updated on the basis of the reading result. In this item management system, the database further stores item aggregation data that defines an item aggregation including N (N is an integer equal to or larger than two) items, from among the plurality of items. In a case where the reading apparatus detects at least M (M is an integer smaller than N) wireless devices, from among the wireless devices attached to the N items included in the same item aggregation, the position information of the N items is updated in accordance with the item aggregation data. According to this configuration, the position information of the items can be collectively updated without forcing the user to perform a cumbersome task such as use the reading apparatus to detect the wireless devices of all of the items included in the item aggregation on an individual basis. Thus, the working time of the user can be reduced and management efficiency can be improved in various applications including production management, stock management, and distribution management, which in particular require tracking of positions of items.

Also, according to the embodiments described above, a reading apparatus capable of measuring a position is used, and in a case where the reading apparatus has detected at least M wireless devices, if the relationship between the detection positions satisfies a predetermined condition, the position information is updated in accordance with the item aggregation data. Thus, position tracking that matches the actual positional relationship of the items under management can be realized by collective updates to the position information upon at least M items being determined to be located close to one another, for example. On the other hand, in a case where a distance between the detection positions of two or more wireless devices included in the same item aggregation detected within a predetermined time period is greater than a threshold, the definition of the item aggregation is canceled. Accordingly, the possibility can be reduced of position information being inappropriately updated in accordance with item aggregation data that does not reflect the actual positional relationship in cases such as when a constituent item of an item aggregation that has been formed is moved separately or one or more items fall.

According to the embodiments described above, a screen for the user to designate an item constituting an item aggregation may be caused to be displayed on a display of a user terminal, and the item designated by the user on the screen may be registered in a database as an item constituting an item aggregation. Therefore, the user can register a definition of an item aggregation after checking whether the item to constitute the item aggregation is appropriate and the related information on the screen. It is sufficient that such a registration task is performed once when an item aggregation is formed, and as long as the constituent items are collectively moved as an item aggregation, tracking of the position of the constituent items can be performed by the simplified process of just detecting some of the constituent items.

According to the embodiments described above, each wireless device is an RFID tag, and the reading apparatus detects each item to which the RFID tag is attached by reading the information sent back from the RFID tag utilizing energy of electromagnetic waves emitted in a readable range. Thus, a battery or a complex transceiver is not required to be installed in the wireless device attached to each item, and even with an item management system that manages many items, the mechanism according to the embodiments described above can be introduced at a low cost.

In a case where the reading apparatus measures the positions on the basis of sensor data output from a three-axis acceleration sensor, a gyro sensor, and a geomagnetic sensor, it is not necessary to communicate with an external apparatus such as GPS satellites or a wireless base station in order to measure a position. Thus, in an environment where external communication is difficult such as when underground, in a tunnel, or indoor, it is possible to track positions of items individually and collectively as an item aggregation.

According to the present invention, it is possible to enhance efficiency of item management.

### 6. Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. An item management system comprising:
a plurality of wireless devices that are respectively attached to a plurality of items;
a reading apparatus that is capable of reading identification information stored in a wireless device; and
a management unit configured to manage a database that stores position information of the plurality of items,
wherein the database further stores item aggregation data that defines an item aggregation including N items (N is an integer equal to or larger than two) out of the plurality of items, and
the management unit is configured to update the position information of the N items included in the item aggregation in accordance with the item aggregation data in a case where at least M wireless devices (M is an integer smaller than N) out of wireless devices attached to the N items have been detected by the reading apparatus.

2. The item management system according to claim 1, wherein the reading apparatus is capable of measuring a position, and
the management unit is configured to update the position information of the N items included in the item aggregation in accordance with the item aggregation data in a case where the at least M wireless devices have been detected by the reading apparatus and a relationship among detection positions satisfies a predetermined condition.

3. The item management system according to claim 2, wherein the predetermined condition includes that no distance between detection positions of the at least M wireless devices detected by the reading apparatus within a predetermined period exceeds a distance threshold.

4. The item management system according to claim 1, wherein the integer M is variably set by a user.

5. The item management system according to claim 3, wherein the distance threshold is variably set by a user.

6. The item management system according to claim 1, wherein the reading apparatus is capable of measuring a position, and
the management unit is configured to cancel the definition of the item aggregation including the N items in a case where a distance between detection positions of two or more wireless devices detected by the reading apparatus within a predetermined period out of wireless devices attached to the N items exceeds a distance threshold.

7. The item management system according to claim 6, wherein the management unit is configured to, in a case where the distance between the detection positions of the two or more wireless devices detected by the reading apparatus within the predetermined period out of wireless devices attached to the N items exceeds the distance threshold:
make an inquiry to a user whether or not to cancel the definition of the item aggregation including the N items; and
refrain from canceling the definition of the item aggregation in a case where the user selects not to cancel the definition of the item aggregation.

8. The item management system according to claim 6, wherein the management unit is configured to cancel the definition of the item aggregation including the N items by giving the item aggregation data defining the item aggregation a flag indicating disablement, by deleting the item aggregation data, or by excluding some items from the definition of the item aggregation.

9. The item management system according to claim 1, wherein the management unit is configured to:
cause a display of a user terminal to display a screen for a user to designate an item that constitutes the item aggregation; and
register an item designated by the user on the screen in the database as an item that constitutes the item aggregation.

10. The item management system according to claim 9, wherein the database further stores respective names of the plurality of items, and
the screen includes a screen element for the user to designate or select a name of an item that constitutes the item aggregation.

11. The item management system according to claim 9, wherein the management unit is configured to:
present a detection result of a wireless device by the reading apparatus to the user on the screen; and
let the user designate an item that constitutes the item aggregation based on the detection result.

12. The item management system according to claim 11, wherein the reading apparatus is capable of measuring a position, and
the management unit is configured to present the detection result to the user by displaying a detection position of a wireless device detected by the reading apparatus on a map image of a place where the reading apparatus has been used.

13. The item management system according to claim 1, wherein updating the position information of the N items included in the item aggregation in the case where the at least M wireless devices have been detected by the reading apparatus includes at least one of: updating position information associated with each of the N items; and updating position information associated with the item aggregation including the N items.

14. The item management system according to claim 1, wherein the wireless device is a radio frequency identification (RFID) tag, and
the reading apparatus is configured to emit an electromagnetic wave to a reading range and detect the wireless device by reading the identification information sent back from the wireless device utilizing energy of the electromagnetic wave.

15. The item management system according to claim 2, wherein the reading apparatus is configured to measure a relative position of the reading apparatus with respect to a reference position based on sensor data output from a three-axis acceleration sensor, a gyro sensor, and a geomagnetic sensor.

16. A method for managing position information of a plurality of items,
wherein a wireless device is attached to each of the plurality of items,
the method comprising:
registering, in a database, item aggregation data that defines an item aggregation including N items (N is an integer equal to or larger than two) out of the plurality of items;
detecting at least M wireless devices (M is an integer smaller than N) out of wireless devices attached to the N items using a reading apparatus that is capable of reading identification information stored in a wireless device; and
updating the position information of the N items included in the item aggregation in accordance with the item aggregation data in response to detecting the at least M wireless devices.

17. An information processing apparatus for managing position information of a plurality of items in a database,
wherein a wireless device is attached to each of the plurality of items,
the information processing apparatus comprising:
a communication unit configured to communicate with a reading apparatus that is capable of reading identification information stored in a wireless device; and
a management unit configured to register, in the database, item aggregation data that defines an item aggregation including N items (N is an integer equal to or larger than two) out of the plurality of items,
wherein the management unit is configured to update the position information of the N items included in the item aggregation in accordance with the item aggregation data in a case where at least M wireless devices (M is an integer smaller than N) out of wireless devices attached to the N items have been detected by the reading apparatus.
